(19) United States
(12) Patent Application Publication
(10) Pub. No.: US 2009/0093584 A1
(43) Pub. Date: Apr. 9, 2009

(54) End Use Applications Prepared From Certain Block Copolymers

(75) Inventors: Richard Gelles, Houston, TX (US); Donn Anthony Dubois, Houston, TX (US); David John St. Clair, Houston, TX (US)

Correspondence Address: KRATON POLYMERS U.S. LLC, WESTHOLLOW TECHNOLOGY CENTER, 3333 HIGHWAY 6 SOUTH, HOUSTON, TX, 77082, US

(73) Assignee: KRATON POLYMERS U.S. LLC, Houston, TX (US)

(21) Appl. No.: 12/248,184

(22) Filed: Oct. 9, 2008

Related U.S. Application Data
(60) Provisional application No. 60/978,484, filed on Oct. 9, 2007.

(51) Int. Cl. C08L 53/00; C08F 120/06

(52) U.S. Cl. 524/505; 524/500; 526/329.7

(57) ABSTRACT

The present invention relates to various end use applications prepared from certain block copolymers. The block copolymers include one or more A or A′ blocks or B blocks plus one or more terminal M blocks. Each A and A′ is a block or segment comprising predominantly a polymerized alkenyl aromatic compound, each B is a block or segment comprising predominantly a polymerized conjugated alkadiene, and each M is a six membered anhydride ring and/or acid group. The anhydride rings are prepared by thermally decomposing adjacent units of (1-methyl-1-alkyl)alkyl acrylic esters such as t-butylmethylacrylate. A wide variety of polymers are disclosed having the stable anhydride rings in the polymer backbone. The invention relates specifically to various end uses prepared from the reaction product of such block copolymers with various reactive resins, reactive monomers and metal derivatives.

### CROSS-REFERENCE TO RELATED APPLICATIONS

The present application claims the benefit of U.S. provisional patent application Ser. No. 60/978,484, filed Oct. 9, 2007, entitled End Use Applications Prepared from Certain Block Copolymers.

### BACKGROUND OF THE INVENTION

1. Field of the Invention

This invention relates to various end use applications prepared from certain block copolymers having anhydride and/or acid groups. The invention relates specifically to various end uses prepared from the reaction product of such block copolymers with various reactive resins, reactive monomers and metal derivatives. In part, the present invention relates to formulations comprising an acrylic polymer grafted with a particular functionalized block copolymer prepared from certain block copolymers having anhydride and/or acid groups.

2. Background of the Art

Elastomeric polymers, both homopolymers and polymers of more than one monomer, are well known in the art. A particularly useful class of synthetic elastomers is the class of thermoplastic elastomers which demonstrates elastomeric properties at ambient temperatures but which is processable at somewhat elevated temperatures by methods more conventionally employed for non-elastomeric thermoplastics. Such thermoplastic elastomers are illustrated by a number of types of block polymers including, for example, block polymers of alkenyl aromatic compounds and conjugated alkadiene. Block polymers of styrene and butadiene are illustrative. This particular type of block polymer is well known in the art and includes KRATON® block copolymers.

The properties of block polymers, even containing the same or similar monomers, will vary considerably with the arrangement of the monomeric blocks within the block polymer and with the relative molecular weight of each block. It is also known that certain of the properties such as resistance to oxidation of this class of block polymers are improved by the selective hydrogenation of some or all of the carbon-carbon unsaturation in the polyalkadiene or aliphatic portion of the molecule and, on occasion, by the hydrogenation of substantially all the carbon-carbon unsaturation including that unsaturation in the poly(alkenyl aromatic compound) or aromatic portion of the molecule. A number of the selectively hydrogenated block polymers are also well known and commercial, such as KRATON® G block copolymers.

An alternate method of modifying selected properties of the block polymers is to provide polarity or functionality within the block polymer as by introducing functional groups as substituents within the molecule or by providing one or more additional blocks within the polymeric structure which are polar in character. Such polymers included maleated block copolymers, such as KRATON® FG block copolymers.

The problem with many of the prior art block copolymers is that they are not polar, reactive, nor hydrophilic. U.S. Pat. No. 5,218,053 discloses a novel polymer that contains anhydride rings. The anhydride rings are prepared by thermally decomposing adjacent units of (1-methyl-1-alkyl)alkyl esters such as in a poly(t-butylmethylacrylate) block. This thermal reaction forms predominately a six-membered glutaric anhydride ring in addition to some carboxylic acid groups. In the case of low reaction conversion, unreacted ester groups may also be present. In addition, the anhydride rings will form at least some carboxylic acid groups upon contact with water. Accordingly, the resulting polymer may contain ester, anhydride and acid groups. A number of polymers were disclosed in the '053 patent having the anhydride rings in the polymer backbone.

### Adhesives, Sealants and Coatings

Such anhydride containing block copolymers have been used to make various adhesives, sealants and coatings as disclosed in U.S. Pat. No. 5,403,658 and US SIR H1251. U.S. Pat. No. 5,403,658 discloses adhesives with aggressive tack (pressure sensitive adhesives) which adhere well to Kraft paper. US SIR H1251 discloses hot melt adhesives which adhere well to polar substrates including steel and glass. Both patents disclose hydrogenated anhydride containing block copolymers. However the prior art does not disclose contact adhesives and coatings and does not disclose the reaction product of anhydride containing block copolymers with reactive resins, reactive monomers and reactive metal derivatives.

### Acrylic Pressure Sensitive Adhesives

Typical acrylic pressure sensitive adhesive formulations are copolymers of alkyl ester monomers, a functional monomer such as acrylic acid, and may be crosslinked using, for example, aluminum chelates. These adhesives are generally deficient in adhesion to low energy surfaces. While adhesives may be tackified with rosin esters to improve low surface energy adhesion, tackification results in loss of heat resistance and poor aging properties. Even though good aging properties are compromised, tackified acrylic dispersions are sufficient for some applications, e.g. most paper label uses and, indeed, have become the dominant paper label technology. These tackified acrylic adhesives, however, do not have sufficient resistance to degradation for most graphics and industrial tape applications in which acrylic solutions are conventionally used.

Rubber-resin formulations are often used to adhere to polyolefins and other low energy substrates. Typical compositions are natural rubber or styrene block copolymers tackified with rosin esters. These formulations provide excellent tack and cohesive strength but discolor and lose tack on aging due to oxidative and UV light induced degradation. Formulations of fully hydrogenated rubbers and resins, besides being more costly, generally do not have the required adhesive performance.

U.S. Pat. No. 5,625,005 discloses rubber-acrylic pressure sensitive adhesives described as having good UV resistance and aging characteristics along with high adhesion to non-polar surfaces. U.S. Pat. Nos. 6,642,298 and 6,670,417 disclose improved acrylic pressure sensitive adhesives containing an acrylic polymer grafted with a hydrogenated rubber macromer. Despite these advances in the art, there remains a need for improved polymer compositions which can be used to prepare pressure sensitive adhesives having sufficient adhesion and chemical resistance properties for applications such as industrial tapes and transfer films, and exterior graphics applications on low energy, difficult to adhere to surfaces.

### Structural Acrylic Adhesives

Structural acrylic adhesives are well known for bonding a wide variety of substrates. They are used as an alternative to mechanical joining methods for a number of reasons including cost, aesthetics, and noise reduction. They typically are made via a mixture of a methacrylate ester monomer, a polymerization catalyst and several other ingredients. Structural acrylic adhesives have several potential drawbacks including poor flexibility and poor adhesion to non-polar surfaces. U.S. Pat. No. 6,989,416 discloses methacrylate structural acrylic adhesives that include elastomeric materials including block copolymers of styrene, and isoprene or butadiene. The elastomeric materials improve the impact strength and flexibility of the adhesive. These block copolymers are used because they can be mixed with methacrylate monomers to create uniform mixtures, and can graft to the acrylic polymer via free radical grafting. However block copolymers of isoprene and butadiene have the drawback of poor UV resistance and aging compared to acrylic polymers.

### Acrylic Sealants and Coatings

Various sealant compositions have been disclosed in the prior art. The basic patent for sealants comprising styrenic block copolymers is Harlan, U.S. Pat. No. 3,239,478, which shows combinations of styrene-diene block copolymers with tackifying resins and the like to produce a wide spectrum of sealants and adhesives. Sealants made with non-hydrogenated styrene-diene block copolymers, such as those disclosed in U.S. Pat. No. 4,101,482 lack the necessary oxidative and UV stability. Sealants based on commercially available hydrogenated styrene-diene block copolymers, such as those disclosed in U.S. Pat. No. 4,113,914, also have certain shortcomings. These sealants have good hardness, temperature resistance and UV resistance, but the failure mechanism is adhesive failure, which failure mechanism is not acceptable in sealants. In addition, the melt viscosity is too high for many commercial operations. A novel sealant composition is disclosed in U.S. Pat. No. 4,296,008 that not only gives better tack and lower melt viscosity (especially in formulations containing no plasticizers), but also results in cohesive as opposed to adhesive failure. However, sealants comprising styrenic block copolymers often contain solvent to lower viscosity. The general trend is away from solvent based sealants because of environmental concerns. While sealants based on acrylic lattices do not match silicone and urethane sealants in performance, they are less expensive and are used in over the counter and do it yourself construction markets. Typically hard acrylic esters like methyl methacrylate, vinyl acetate, and methyl acrylate are used in combination with monomers which give flexibility including butyl acrylate and 2-ethylhexyl acrylate. In general, acrylic adhesives, sealants and coatings exhibit excellent ultraviolet (uv) stability and resistance to thermal degradation. However, acrylic based adhesives sealants and coatings in general suffer from poor adhesion to low energy and low polarity surfaces and rigid acrylics suffer from poor flexibility and impact strength.

### Radiation Cured Adhesives, Sealants, Coatings and Printing Plates

Monoalkenyl arene/conjugated diene block copolymers are widely used in pressure sensitive adhesives (PSA). PSA based on these polymers have high strength and elasticity at ambient temperatures, making them well suited for use in many general purpose applications, and in packaging and cloth tapes. The high strength and elasticity of these PSAs is due to the well known microphase separated network structure in which the monoalkenyl arene endblocks, phase separate to form domains serving to physically crosslink the rubbery midblock phase. However, at temperatures approaching the glass transition temperature of the endblocks or in the presence of an appropriate solvent, the domains soften, releasing the physical crosslinks and the PSA loses its strength and elasticity. Therefore, PSA based on a block copolymer are unsuitable for use in high temperature or solvent resistant tapes, such as automobile masking tapes. The only method of maintaining high cohesive strength in a PSA based on a block copolymer at high temperature or in the presence of solvent is to chemically crosslink the polymer in order that the polymer no longer depends on the physical crosslinks for its strength.

Radiation cured adhesives, sealants and coatings are well known in the art and can be divided into ultraviolet (UV), visible light curable and electron beam curable formulations. Examples of the prior art include U.S. Pat. No. 5,777,039 U.S. Pat. No. 4,556,464 and U.S. Pat. No. 4,133,731. In general, adhesives, sealants and coatings are cured (crosslinked) to improve mechanical properties at elevated temperature like cohesive strength, shear strength and creep resistance. Curing by radiation requires monomers and polymers with functional groups. Monomers and polymers with acrylic functionality are often used. Monomers and polymers with epoxy functionality can be used for cationic curing, and monomers and polymers with thiol functionality may also be used for radiation cure. However, the polymers of the prior art continue to have certain shortcomings, including the lack of acceptable resistance to aging and UV light.

What has now been found is that the novel block copolymer compositions of the present invention have surprising property advantages, and show promising utility in a variety of end-use applications. The present invention overcomes several limitations in the prior art, for example permitting the preparation of contact adhesives with improved cohesive strength, and coatings with improved toughness or flexibility. The present invention is an improvement over past acrylic adhesives, sealants and coatings, and the novel formulations claimed here exhibit excellent adhesion to low energy and low polarity surfaces.

### SUMMARY OF THE INVENTION

As used herein, the term “hybrid block copolymer” refers to a block copolymer composition comprising (1) at least one block of a polymerized conjugated diene (or hydrogenated version) or a polymerized alkenyl aromatic and at least one end block comprising a repeat unit of a six membered anhydride ring (or a reaction product of a six membered anhydride ring with water to form the corresponding carboxylic acid) and (2) a reactive monomer or reactive resin or reactive metal derivative that will react with the anhydride and/or acid groups. Furthermore, the base block copolymer can also contain unreacted alkyl methacrylate repeats in addition to anhydride or the open-ring carboxylic acid. In a preferred embodiment, the hybrid block copolymers are prepared by a process comprising the steps of:
(a) anionically polymerizing a conjugated alkadiene or an alkenyl aromatic compound to form living polymer molecules;
(b) anionically polymerizing a methacrylic or acrylic monomer bearing a (1-methyl-1-alkyl)alkyl ester to form adjacent units of the ester on the living polymer molecules;
(c) recovering the polymer molecules;
(d) heating the polymer molecules to convert at least some of the adjacent ester groups to anhydride rings (the process of (c) may provide sufficient heat to convert the ester groups to anhydride); and
(e) reacting the resulting polymer with a reactive monomer or resin or metal derivative.

As used herein, the term “pressure-sensitive adhesive” refers to a viscoelastic material which adheres instantaneously to most substrates with the application of slight pressure and remains permanently tacky. A polymer is a pressure-sensitive adhesive within the meaning of the term as used herein if it has the properties of a pressure-sensitive adhesive per se or functions as a pressure-sensitive adhesive by admixture with tackifying resins, plasticizers or other additives. As used herein the term “structural adhesive” refers to a bonding agent used to transfer loads between adherents. Structural adhesives can be rigid or flexible and typically have high strength, durability and heat resistance. The term “sealant” refers to a material that fills the gap between two substrates and gives a tight and perfect closure against the passage of a liquid such as water or a gas or vapor such as water vapor. The term “coating” refers to a material that is spread over and adheres to a substrate and provides some property advantage to the substrate.

Preferably the reactive resins are selected from the group consisting of phenolic resins, amino resins, epoxy resins and polyurethanes. Preferably the reactive monomers are selected from the group consisting of hydroxy functional monomers, carboxy functional monomers, glycidyl functional monomers, acrylamide functional monomers, amine functional monomers, epoxy functional monomers, isocyanate functional monomers and mixtures thereof. Preferably the metal derivatives are selected from the group consisting of calcium oxide, magnesium oxide, zinc oxide, calcium stearate, zinc stearate, zinc acetate and mixtures thereof.

The present invention provides adhesive, sealant and coating formulations prepared from certain acrylic polymers or acrylic monomers and with a particular functionalized block copolymer prepared from certain block copolymers having anhydride and/or acid groups.

These various formulations are novel, and result in products having unexpected property advantages. For example, the resulting adhesive formulations have outstanding coating characteristics, adhesion to a wide variety of substrates, including low energy surfaces, while maintaining these performance properties at higher temperatures in their dried state.

The present invention claims various new compositions of matter, including:
(1) a functionalized block copolymer comprising the reaction product of (i) a block copolymer comprising at least one block of a polymerized conjugated diene and/or a polymerized alkenyl aromatic and at least one end block comprising a six membered anhydride ring and/or the corresponding carboxylic acid formed from the reaction of this ring and water and (ii) at least one reactive monomer. In a preferred embodiment the reactive monomer is selected from hydroxy functional monomers, carboxy functional monomers, glycidyl functional monomers, acrylamide functional monomers, amine functional monomers, epoxy functional monomers, isocyanate functional monomers and mixtures thereof;
(2) a functionalized block copolymer comprising the reaction product of (i) a block copolymer comprising at least one block of a polymerized conjugated diene and/or a polymerized alkenyl aromatic and at least one end block comprising a six membered anhydride ring and/or the corresponding carboxylic acid formed from the reaction of this ring and water and (ii) at least one acrylic copolymer containing at least one pendant reactive group;
(3) a functionalized block copolymer comprising the reaction product of (i) a block copolymer comprising at least one block of a polymerized conjugated diene and/or a polymerized alkenyl aromatic and at least one end block comprising a six membered anhydride ring and/or the corresponding carboxylic acid formed from the reaction of this ring and water and (ii) at least one reactive resin selected from the group consisting of phenolic resins, amino resins, polyurethanes and epoxy resins; and
(4) an acrylic composition comprising an acrylic polymer reacted with a block copolymer, wherein said acrylic copolymer has a glass transition temperature below 0° C. and contains at least one vinylic comonomer unit possessing a pendant reactive group capable of reacting with said block copolymer and wherein said block copolymer comprises at least one block of a polymerized conjugated diene and/or a polymerized alkenyl aromatic and at least one end block comprising a six membered anhydride ring and/or acid.

In a further preferred embodiment, the hybrid block copolymers prior to heating to form the anhydride rings and reaction with the functional monomer comprise (a) a block of polymerized styrene, (b) a block of polymerized, hydrogenated butadiene having at least some 1,2-enchainments, or a block of polymerized, hydrogenated isoprene, or a block of polymerized, hydrogenated isoprene and butadiene and (c) a terminal block of polymerized t-butyl methacrylate polymerized through the ethylenic unsaturation thereof, wherein the block copolymer has the formula

A-M, B-M, B-A-M, A-B-M or A-B-A′-M

wherein A and A′ are blocks of the polymerized aromatic styrene, B is the block of the hydrogenated, polymerized butadiene, isoprene or mixtures of butadiene and isoprene, and M is the terminal block of the polymerized t-butyl methacrylate, and wherein each block of the polymerized styrene has a number average molecular weight from about 2,000 to about 50,000, the block of the hydrogenated, polymerized diene has a number average molecular weight from about 20,000 to about 500,000, and the terminal M block has a number average molecular weight of 500 to about 100,000.

In one aspect of the present invention we have discovered a novel contact adhesive composition, said contact adhesive comprising at least one block copolymer, a reactive resin, and a solvent. In a preferred embodiment the contact adhesive comprises 100 parts by weight of at least one base block copolymer, 20 to 500 parts by weight of a heat reactive phenolic resin, 1 to 10 parts by weight of a metal oxide such as magnesium oxide, and a solvent, such as toluene or a solvent blend of toluene, hexane or heptane and acetone.

In another aspect of the present invention we have discovered a novel solvent based adhesive composition comprising 100 parts by weight of at least one hybrid block copolymer, 25 to 300 parts by weight of at least one tackifying resin, and 0 to 200 parts by weight of a plasticizer and a solvent or solvent mixture.

In another aspect of the present invention we have discovered a novel composition comprising the hybrid block copolymers of the present invention prepared by reaction of the base polymer with monomers and resins containing epoxy, isocyanate and amine functional groups. These compositions include novel epoxy compositions, ambient cure urethane compositions and bake cure compositions.

One aspect of the invention relates to an acrylic composition comprising (a) an acrylic polymer containing pendant reactive groups and/or (b) an acrylic monomer containing pendant reactive groups, said monomer or polymer being reacted with a block copolymer wherein said block copolymer comprises at least one block of a polymerized conjugated diene and/or a polymerized alkenyl aromatic and at least one end block comprising a six membered anhydride ring and/or acid. Preferred acrylic polymers have a glass transition temperature below 0° C., containing at least one comonomer unit possessing a pendant reactive group and preferred acrylic monomers include methyl acrylate, ethyl acrylate, isobutyl methacrylate, and methyl methacrylate.

Another aspect of the invention is directed to a pressure-sensitive adhesive comprising an acrylic polymer copolymerized with a block copolymer, wherein said acrylic polymer comprises: (a) at least one alkyl acrylate monomer containing from about 4 to about 18 carbon atoms in the alkyl group, (b) at least one monomer selected from the group consisting of methyl acrylate, ethyl acrylate, isobutyl methacrylate, vinyl acetate, methyl methacrylate, acrylonitrile, styrene, and mixtures thereof; and (c) at least one reactive monomer selected from hydroxy functional monomers, carboxy functional monomers, glycidyl functional monomers, acrylamide functional monomers, amine functional monomers, epoxy functional monomers, isocyanate functional monomers and mixtures thereof, and wherein said block copolymer comprises at least one block of a polymerized conjugated diene and/or a polymerized alkenyl aromatic and at least one end block comprising a six membered anhydride ring and/or acid.

Another aspect of the invention is directed to a pressure-sensitive adhesive comprising an acrylic polymer copolymerized with a functionalized block copolymer, wherein said acrylic polymer comprises: (a) at least one alkyl acrylate monomer containing from about 4 to about 18 carbon atoms in the alkyl group, and (b) at least one monomer selected from the group consisting of methyl acrylate, ethyl acrylate, isobutyl methacrylate, vinyl acetate, methyl methacrylate, acrylonitrile, styrene, and mixtures thereof, and wherein said functionalized block copolymer comprises the reaction product of (i) a block copolymer comprising at least one block of a polymerized conjugated diene and/or a polymerized alkenyl aromatic and at least one end block comprising a six membered anhydride ring and/or acid and (ii) at least one reactive monomer selected from hydroxy functional monomers, carboxy functional monomers, glycidyl functional monomers, acrylamide functional monomers, amine functional monomers, epoxy functional monomers, isocyanate functional monomers and mixtures thereof.

Still another aspect of the invention is directed to a process of making a pressure-sensitive adhesive comprising reacting (a) at least one alkyl acrylate monomer containing from about 4 to about 18 carbon atoms in the alkyl group with (b) at least one monomer selected from the group consisting of methyl acrylate, ethyl acrylate, isobutyl methacrylate, vinyl acetate, methyl methacrylate, acrylonitrile, styrene, and mixtures thereof and mixtures thereof, and with (c) a functionalized block copolymer, wherein said functionalized block copolymer comprises the reaction product of (i) a block copolymer comprising at least one block of a polymerized conjugated diene or a polymerized alkenyl aromatic and at least one end block comprising a six membered anhydride ring and/or acid and (ii) at least one reactive monomer selected from hydroxy functional monomers, carboxy functional monomers, glycidyl functional monomers, acrylamide functional monomers, amine functional monomers, epoxy functional monomers and mixtures thereof.

Yet another aspect of the invention is directed to adhesive articles, e.g., industrial tapes, transfer films, and the like, comprising a pressure sensitive adhesive hybrid polymer. In one particularly preferred embodiment, the hybrid polymer comprises an acrylic polymer copolymerized with a functionalized block copolymer, wherein said acrylic polymer comprises: (a) at least one alkyl acrylate monomer containing from about 4 to about 18 carbon atoms in the alkyl group, and (b) at least one monomer selected from the group consisting of methyl acrylate, ethyl acrylate, isobutyl methacrylate, vinyl acetate and mixtures thereof, and wherein said functionalized block copolymer comprises the reaction product of (i) a block copolymer comprising at least one block of a polymerized conjugated diene or a polymerized alkenyl aromatic and at least one end block comprising a six membered anhydride ring and/or acid and (ii) at least one reactive monomer selected from hydroxy functional monomers, carboxy functional monomers, glycidyl functional monomers, acrylamide functional monomers, amine functional monomers, epoxy functional monomers and mixtures thereof.

The largest consumption of acrylic adhesives and sealants is with acrylic polymers prepared by emulsion polymerization. Emulsion polymerized acrylics give acrylic polymer, adhesive, sealant and coating manufacturing processes and end user application processes which are low cost and environmentally friendly. The present invention describes a hybrid rubber-acrylic polymer which can be prepared in solution, in a mixture of monomers, in an emulsion or suspension of monomers, or in the melt.

The block copolymer can be reacted with the acrylic monomers during copolymerization (a “macromer” process), or alternatively, the block copolymer can be reacted with a polymerized acrylic polymer by reaction between the functional monomers in the acrylic polymer and the end block comprising a six membered anhydride ring or the acid formed from the reaction of this ring and water (the post polymerization reaction process). These two processes are shown schematically below:

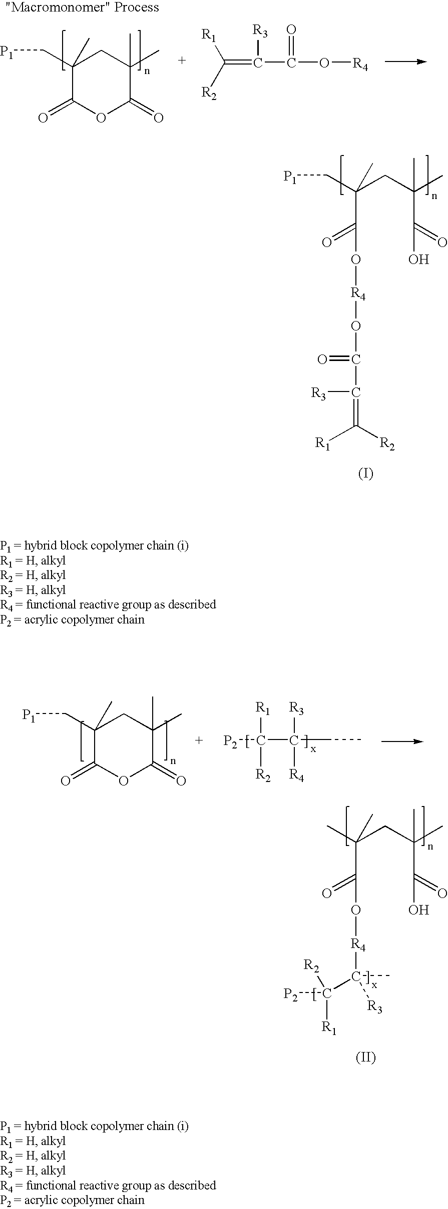

The present invention describes acrylic polymers grafted with the block copolymers described above. Thus the hydrogenated block copolymer segments, in particular the rubber phase, impart improved adhesion to low energy surfaces, as in the prior art, but give improved cohesive strength and flow resistance at elevated temperature compared to the prior art in the case of pressure sensitive adhesives, and gives improved uv weathering and heat aging stability compared to the prior art in the case of structural adhesives.

### DETAILED DESCRIPTION OF THE PREFERRED EMBODIMENTS

The key component of the present invention is the hybrid block copolymer composition as defined above. The process for making the starting base block copolymer is described and claimed in the U.S. Pat. No. 5,218,053, which disclosure is herewith incorporated by reference.

The base polymers of the present invention prior to formation of the anhydride rings are exemplified by the following structures:

| | |
|---|---|
| A-M | I |
| B-M | II |
| B-M-B | III |
| M-B-M | IV |
| (B-M-)_{y}-X | V |
| (M-B-)_{y}-Z | VI |
| A-B-M | VII |
| B-A-M | VIII |
| A-B-A′-M | IX |
| M-A-B-A′-M | X |
| (A-B-M-)_{y}-X | XI |
| (M-A-B-)_{y}-Z | XII |
| (M-B-A-)_{y}-Z | XIII |
| (A-M-)_{y}-X | XIV |
| (M-A-)_{y}-Z | XV |

wherein each A and A′ is a block or segment comprising predominantly a polymerized alkenyl aromatic compound, each B is a block or segment comprising predominantly a polymerized conjugated alkadiene, each M is a segment or block comprising at least two adjacent units of a polymerized (1-methyl-1-alkyl)alkyl ester, y is an integer representing multiple arms in a star configuration, X is the residue of a polyfunctional coupling agent, and Z is a crosslinked core of a polyfunctional coupling agent or a polyfunctional polymerization initiator.

The alkenyl aromatic compound employed as each A and A′ block or segment in some of the above structures is a hydrocarbon compound of up to 18 carbon atoms having an alkenyl group of up to 6 carbon atoms attached to a ring carbon atom of an aromatic ring system of up to 2 aromatic rings. Such alkenyl aromatic compounds are illustrated by styrene, 2-butenylnaphthalene, 4-t-butoxystyrene, 3-isopropenylbiphenyl, and isopropenylnaphthalene. The preferred alkenyl aromatic compounds have an alkenyl group of up to 3 carbon atoms attached to a benzene ring as exemplified by styrene and styrene homologs such as styrene, α-methylstyrene, p-methylstyrene, and α,4-dimethylstyrene. Also included are monomers such as 1,1-diphenylethylene monomer, 1,2-diphenylethylene monomer, and mixtures thereof. Styrene and α-methylstyrene are particularly preferred alkenyl aromatic compounds, especially styrene.

Each A and A′ block or segment of the polymers is preferably at least 80% by weight polymerized alkenyl aromatic compound and is most preferably a homopolymer. Each B block or segment in the structures of Formula II-XIII preferably comprises at least 90% by weight of the polymerized conjugated alkadiene. Most preferably, the B segments or blocks are homopolymers or copolymers of one or more conjugated alkadienes. The conjugated alkadienes preferably have up to 8 carbon atoms. Illustrative of such conjugated alkadienes are 1,3-butadiene (butadiene), 2-methyl-1,3-butadiene (isoprene), 1,3-pentadiene (piperylene), 1,3-octadiene, and 2-methyl-1,3-pentadiene. Preferred conjugated alkadienes are butadiene and isoprene, particularly butadiene. Within the preferred polyalkadiene blocks or segments of the polymers of Formula II-XIII, the percentage of units produced by 1,4 polymerization is at least about 5% and preferably at least about 20%. In addition, copolymers of conjugated dienes and alkenyl aromatics are also included, where the structure may be a random copolymer, a tapered copolymer or a controlled distribution block copolymer. Controlled distribution block copolymers are disclosed in U.S. Pat. No. 7,169,848, which disclosure is herein incorporated by reference.

Each M is preferably a methacrylate block or segment comprising at least two adjacent units of a polymerized (1-methyl-1-alkyl)alkyl methacrylate. Homopolymeric M segments or blocks of (1-methyl-1-alkyl)alkyl methacrylates are most preferred.

The alkyl esters have the following structure:

### Monomer:

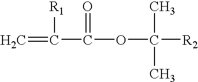

### Anhydride Ring:

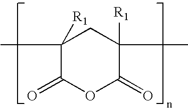

### Reaction of Ester to Anhydride

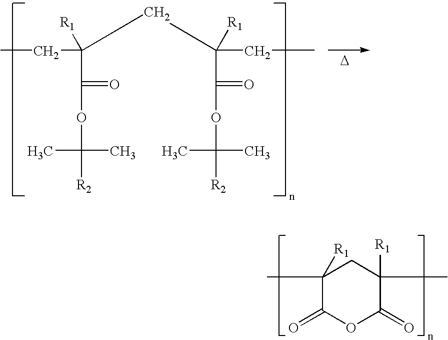

wherein R₁ is hydrogen or an alkyl or aromatic group comprising from 1 to 10 carbon atoms and R₂ is an alkyl group comprising from 1 to 10 carbon atoms.

Adjacent (1-methyl-1-alkyl)alkyl ester groups thermally convert to stable anhydride rings having six members after reaction.

Examples of the (1-methyl-1-alkyl) alkyl esters include:
1,1-dimethylethylacrylate(t-butylacrylate),
1,1-dimethylpropylacrylate(t-pentylacrylate),
1,1-dimethylethyl-α-propylacrylate,
1-methyl-1-ethylpropyl-α-butylacrylate,
1,1-dimethylbutyl-α-phenylacrylate,
1,1-dimethylpropyl-α-phenylacrylate(t-pentylatropate),
1,1-dimethylethyl-α-methylacrylate, (t-butylmethylacrylate), and
1,1-dimethylpropyl-α-methylacrylate(t-pentylmethacrylate).

The most preferred alkyl ester is t-butylmethacrylate which is commercially available in high purity from Mitsubishi-Rayon, Japan. Another source of high purity monomer can be obtained from BASF. Mixture of the alkyl esters of above and other esters, which do not thermally convert to anhydride groups, preferably isobutylmethylacrylate (3-methylpropyl-α-methylacrylate), can be used if M blocks having both ester and anhydride functional groups are desired. Alternatively, the anhydride reaction temperature and residence time can be reduced to afford a mixed block of unreacted ester and six-membered anhydride.

The processes for producing the polymers of Formula I-XV are, at least in part, rather particular because of the tendency of the ester groups to undergo side reactions with polymer lithium species. In the process of producing a more conventional polymer, e.g., a block polymer of styrene and 1,3-butadiene, a variety of process schemes are available. Such procedures include the production by anionic polymerization of a living polymer of either type of monomer before crossing over to the polymerization of the other type of monomer. It is also conventional to produce such block polymers by sequential polymerization or by the use of coupling agents to obtain branched or radial polymers. In the production of the polymers of the invention, the aliphatic and aromatic portions are produced by sequential polymerization and the ester block is then produced as a final polymerization step prior to termination or any addition of coupling agents.

In each procedure to form a polymer of Formulas I-XV the monomers are anionically polymerized in the presence of a metal alkyl initiator, preferably an alkali metal alkyl. The use of such initiators in anionic polymerizations is well known and conventional. A particularly preferred initiator is sec-butyllithium.

The polymerization of the alkenyl aromatic compounds takes place in a non-polar hydrocarbon solvent such as cyclohexane or in mixed polar/non-polar solvents, e.g., mixtures of cyclohexane and an ether such as tetrahydrofuran or diethyl ether. Suitable reaction temperatures are from about 20° C. to about 80° C. and the reaction pressure is sufficient to maintain the mixture in the liquid phase. The resulting product includes a living poly(alkenyl aromatic compound) block having a terminal organometallic site which is used for further polymerization.

The polymerization of the conjugated alkadiene takes place in a solvent selected to control the mode of polymerization. When the reaction solvent is non-polar, the desired degree of 1,4 polymerization takes place whereas the presence of polar material in a mixed solvent results in an increased proportion of 1,2 polymerization. Polymers resulting from about 6% to about 95% of 1,2 polymerization are of particular interest. In the case of 1,4 polymerization, the presence of ethylenic unsaturation in the polymeric chain results in cis and trans configurations. Polymerization to give a cis configuration is predominant.

Polymerization of the esters takes place in the mixed solvent containing the polymerized conjugated alkadiene at a temperature from about −80° C. to about 100° C., preferably from about 10° C. to about 50° C.

Subsequent to production of the acrylic block or segment, the polymerization is terminated by either reaction with a protic material, typically an alkanol such as methanol or ethanol or with a coupling agent. A variety of coupling agents are known in the art and can be used in preparing the coupled block copolymers of the present invention. These include, for example, dihaloalkanes, silicon halides, siloxanes, multifunctional epoxides, silica compounds, esters of monohydric alcohols with carboxylic acids, (e.g. methylbenzoate and dimethyl adipate) and epoxidized oils. Star-shaped polymers are prepared with polyalkenyl coupling agents as disclosed in, for example, U.S. Pat. Nos. 3,985,830; 4,391,949; and 4,444,953; as well as Canadian Patent No. 716,645, each incorporated herein by reference. Suitable polyalkenyl coupling agents include divinylbenzene, and preferably m-divinylbenzene. Preferred are tetra-alkoxysilanes such as tetra-methoxysilane (TMOS) and tetra-ethoxysilane (TEOS), tri-alkoxysilanes such as methyltrimethoxysilane (MTMS), aliphatic diesters such as dimethyl adipate and diethyl adipate, and diglycidyl aromatic epoxy compounds such as diglycidyl ethers deriving from the reaction of bis-phenol A and epichlorohydrin. Coupling with a polymerizable monomer such as divinylbenzene does not terminate the polymerization reaction. Termination to remove the lithium is preferred after coupling with divinylbenzene although additional arms can be grown from the lithium sites before termination if desired. The polymers are then recovered by well known procedures such as precipitation or solvent removal.

The polymers produced by the above procedures will undergo some coupling through an ester group on an adjacent living molecule prior to termination unless the living polymer chains are first end-capped with a unit of 1,1-diphenylethylene or α-methylstyrene. Ester coupling occurs in about 10-50% of the polymer by weight if left unchecked. Such coupling is often acceptable, particularly when the desired polymer structure requires coupling after polymerization of the esters.

The production of the polymers of Formula IV and X is somewhat different procedurally, although the process technology is broadly old. In this modification, conjugated alkadiene is polymerized in the presence of a difunctional initiator, e.g., 1,3-bis(1-lithio-1,3-dimethylpentyl)benzene, to produce a living polyalkadiene species with two reactive organometallic sites. This polymer species is then reacted with the remaining monomers to produce the indicated structures.

The production of the polymers of Formula VI, XII, and XIII and XV is also different procedurally, although the process technology again is broadly old. In this modification, a multifunctional initiator identified as core Z is first produced by anionically polymerizing small molecules of living polystyrene or a living conjugated alkadiene and coupling the small molecules with divinylbenzene to provide numerous organometallic sites for further polymerization.

Each B segment or block has a molecular weight from 2,000 to 500,000 prior to any coupling, preferably from 2,000 to 200,000. Each A block has a molecular weight from 500 to 30,000 prior to any coupling, preferably from 1,000 to 20,000. Each non-coupled M segment or block has a molecular weight from 200 to 100,000, preferably from 200 to 30,000, prior to conversion to an anhydride.

In a further modification of the base polymers of Formula II-XIII used in the invention, the base polymers are selectively hydrogenated to reduce the extent of unsaturation in the aliphatic portion of the polymer without substantially reducing the aromatic carbon-carbon unsaturation of any aromatic portion of the block copolymer. However, in some cases hydrogenation of the aromatic ring is desired. Thus, a less selective catalyst will work.

A number of catalysts, particularly transition metal catalysts, are capable of selectively hydrogenating the aliphatic unsaturation of a copolymer of an alkenyl aromatic compound and a conjugated alkadiene, but the presence of the M segment or block can make the selective hydrogenation more difficult. To selectively hydrogenate the aliphatic unsaturation it is preferred to employ a “homogeneous” catalyst formed from a soluble nickel or cobalt compound and a trialkylaluminum. Nickel naphthenate or nickel octoate is a preferred nickel salt. Although this catalyst system is one of the catalysts conventionally employed for selective hydrogenation absent alkyl methacrylate blocks, other “conventional” catalysts are not suitable for selective hydrogenation of the conjugated alkadienes in the ester containing polymers.

In the selective hydrogenation process, the base polymer is reacted in situ, or if isolated is dissolved in a suitable solvent such as cyclohexane or a cyclohexane-ether mixture and the resulting solution is contacted with hydrogen gas in the presence of the homogeneous nickel or cobalt catalyst. Hydrogenation takes place at temperatures from about 25° C. to about 150° C. and hydrogen pressures from about 15 psig to about 1000 psig. Hydrogenation is considered to be complete when at least about 90%, preferably at least 98%, of the carbon-carbon unsaturation of the aliphatic portion of the base polymer has been saturated, as can be determined by nuclear magnetic resonance spectroscopy. Under the conditions of the selective hydrogenation no more than about 5% and preferably even fewer of the units of the A and A′ blocks will have undergone reaction with the hydrogen. The selectively hydrogenated block polymer is recovered by conventional procedures such as washing with aqueous acid to remove catalyst residues and removal of the solvent and other volatiles by evaporation or distillation.

The anhydride groups in the polymers of the invention are produced by heating the base polymers to a temperature in excess of 180° C., preferably 220° C. to 260° C. Heating is preferably conducted in an extruder having a devolatilization section to remove the volatile by-products formed by combination of two adjacent ester groups to make one anhydride group.

The polymers preferably have the following number average molecular weights after conversion to anhydride as measured by gel permeation chromatography:

| | Preferred Range | | Most Preferred | |
|---|---|---|---|---|
| Formula | Min. MWₙ | Max. MWₙ | Min. MWₙ | Max. MWₙ |
| I | 1,000 | 500,000 | 1,000 | 100,000 |
| II | 1,000 | 1,000,000 | 1,000 | 500,000 |
| III | 1,000 | 2,000,000 | 1,000 | 500,000 |
| IV | 1,000 | 2,000,000 | 1,000 | 500,000 |
| V | 1,000 | 2,000,000 | 1,000 | 1,000,000 |
| VI | 1,000 | 2,000,000 | 1,000 | 500,000 |
| VII | 1,000 | 2,000,000 | 20,000 | 1,000,000 |
| VIII | 1,000 | 2,000,000 | 20,000 | 2,000,000 |
| IX | 1,000 | 2,000,000 | 35,000 | 2,000,000 |
| X | 1,000 | 2,000,000 | 1,000 | 650,000 |
| XI | 1,000 | 2,000,000 | 1,000 | 1,000,000 |
| XII | 1,000 | 2,000,000 | 1,000 | 1,000,000 |
| XIII | 1,000 | 2,000,000 | 1,000 | 1,000,000 |
| XIV | 1,000 | 2,000,000 | 1,000 | 200,000 |
| XV | 1,000 | 2,000,000 | 1,000 | 1,000,000 |

Both absolute and number average molecular weights are determined by conventional GPC as described in the examples below.

While the hybrid polymers containing predominately anhydride groups may be used, it is likely that some of the anhydride groups will be converted to acid groups by contact with water. In many cases this is a desired aspect, for example in an emulsion the anhydride groups at the surface of a polymer or formulation particle is in contact with water and will form the acid, or an acid salt if a base such as sodium hydroxide is added to the water. Since the hybrid polymer in the acid or acid salt form is active as a surfactant, it will help to stabilize the emulsion and give stability at lower levels of low molecular weight surfactant. In any case the range of content of the M block may vary, as shown below. The sum of the ester, anhydride and acid forms will equal 100 wt %:

| | Wt. % Ester | Wt. % Anhydride | Wt. % Acid |
|---|---|---|---|
| Broad Range | 0 to 50% | 0 to 100% | 0 to 100% |
| Preferred Range | 0 to 20% | 50 to 100% | 0 to 50% |

Carboxy functional monomers include carboxylic acids. Such carboxylic acids preferably contain from about 3 to about 5 carbon atoms and include, among others, acrylic acid, methacrylic acid, itaconic acid, and the like. Acrylic acid, methacrylic acid and mixtures thereof are preferred. Specific examples of hydroxy functional monomers include hydroxyethyl acrylate, hydroxypropyl acrylate, hydroxyethyl methacrylate and hydroxypropyl methacrylate. Specific examples of glycidyl functional monomers include glycidyl methacrylate and glycidyl acrylate. Specific examples of acrylamide functional monomers include N-alkyl(meth)acrylamides such as t-octyl acrylamide, cyanoethylacrylates, and diacetoneacrylamide, Other functional monomers include amine functional monomers, epoxy functional monomers, isocyanate functional monomers and mixtures thereof. Examples of functional resins include phenolic resins, amino resins, polyurethanes and epoxy resins. Specific examples of metal derivatives include but are not limited to calcium oxide, magnesium oxide, zinc oxide, calcium stearate, zinc stearate, zinc acetate and the like. The metal derivative must be capable of forming ionic bonds with the anhydride or acid groups on the base polymer or with the acid or phenolic groups on the resin.

The functional monomer is added to the block copolymer in amounts ranging from about one functional monomer per base polymer molecule to about one functional monomer per starting anhydride and acid group on the base polymer. Reaction conditions vary from room temperature to 350° C., preferably from room temperature to 260° C. Reaction conditions depend on the specific functional monomer. For example, monomers which contain hydroxyl groups can react with the base polymer at room temperature, but this reaction is slow so that it is advantageous to carry it out at higher temperatures, but not at temperatures which will cause the base polymer to degrade. Optionally, a catalyst can be used to aid this reaction.

The characterization of the resulting polymer will depend on the specific functional monomer, reactive resin, or metal derivative reacted with the base polymer. In general, methods such as IR and NMR combined with various separation methods can be used to show that a chemical reaction has taken place between anhydride and acid groups on the base polymer and reactive monomers, resins and metal derivatives. GPC can be used for characterization if there is a large molecular weight change as a result of reaction, In the case of reaction giving a cured system, the resulting polymer or formulation can be characterized in terms of insolubles (gel level) or by mechanical and rheological properties.

### Contact Adhesives

The term “contact adhesive” means an adhesive composition which, in use, is applied to the surfaces to be adhered and is allowed to dry, preferably to a substantially tack-free or touch-dry state, before the surfaces are brought together to effect a bond. According to the present invention, a method of adhering two surfaces together comprises applying a one-part contact adhesive composition as defined herein to the surfaces to be adhered, and bringing the surfaces into contact with each other after at least some of the organic liquid has evaporated.

Preferably the adhesive of this invention is non-fluid or gel-like in a state of rest at ambient temperatures. However, owing to its thixotropic nature it becomes fluid when agitated, for example by stirring or vibrating.

The organic liquid may be any of those which dissolve and/or disperse the hybrid block copolymer. Often the hybrid block copolymer may be partly dissolved and partly dispersed by the organic liquid. Solvents include inexpensive aliphatic hydrocarbons such as hexane or heptane or their isomers, aromatic hydrocarbon solvents such as toluene and xylene, and oxygenated solvents including ketones like acetone and methyl ethyl ketone, alcohols such as isopropyl alcohol, and esters such as ethyl acetate and tert butyl acetate. The choice of solvent affects several properties of the adhesive including the rate of strength development, open time, cost, viscosity, and sprayability. Solvent blends are often used to control properties of the adhesive.

Other ingredients may be included in the composition to confer or modify a property. Examples of additional ingredients are fillers, pigments, reinforcing polymeric materials such as chlorinated natural rubber, resins of hydrocarbyl-phenols, hydrocarbyl-phenol resin-modifying agents, magnesium oxide, resins of amino compounds with aldehydes, polystyrene block compatible resins and conjugated diene block compatible resins. The polystyrene block compatible resin may be selected from the group consisting of coumarone-indene resin, polyindene resin, poly(methyl indene) resin, polystyrene resin, vinyltoluene-alphamethylstyrene resin, alphamethylstyrene resin and polyphenylene ether, in particular poly(2,6-dimethyl-1,4-phenylene ether). Such resins are e.g. sold under the trademarks “HERCURES”, “ENDEX”, “KRISTALEX”, “NEVCHEM”and “PICCOTEX”. Resins compatible with the hydrogenated (conjugated diene) block may be selected from the group consisting of compatible C₅ hydrocarbon resins, hydrogenated C₅ hydrocarbon resins, styrenated C₅ resins, C₅/C₉ resins, styrenated terpene resins, fully hydrogenated or partially hydrogenated C₉ hydrocarbon resins, rosins esters, rosin derivatives and mixtures thereof. These resins are e.g. sold under the trademarks “REGALITE”, “REGALREZ”, “ESCOREZ”, “OPPERA”, “WINGTACK” and “ARKON”.

If an improvement in cohesive strength, adhesion, and upper service temperature (resistance to flow under load above room temperature) is desired, especially when the surfaces to be adhered are non-porous, it is often preferred to include in the composition a polar resin such as a hydrocarbyl-phenol and formaldehyde resin or a resin which is a product of amino compounds and aldehydes. Examples of hydrocarbyl-phenols are octyl, amyl and tertiary-butyl phenols and para-cresols. Examples of amino compounds are urea and melamine. An example of an aldehyde is formaldehyde. When a heat-reactive hydrocarbyl-phenol resin is employed it is preferred to employ a modifying agent such as magnesium oxide. The amount of magnesium oxide employed may be, for example, up to 20 parts by weight, and preferably in the range of from 1 to 10 parts by weight, per 100 parts by weight of hybrid block copolymer in the composition. The weight ratio of magnesium oxide: resin may suitably be in the range 1:100 to 50:100 and is preferably in the range 5:100 to 40:100, especially in the range 5:100 to 25:100. A large improvement in cohesive strength is obtained when either the base block copolymer and/or the resin can react with itself or each other. The hybrid block copolymer can be pre-reacted with the resin prior to application of the adhesive to improve compatibility and storage stability of the solvent based composition. Reaction means chemical bonds are formed. Chemical bonds include but are not limited to covalent bonds, ionic bonds and hydrogen bonds. For example, a contact adhesive is prepared comprising an amino resin and the base polymer containing anhydride groups so that amide or imide covalent bonds are formed between the resin and polymer. For example, a contact adhesive is prepared comprising a metal derivative such as a metal oxide or a metal salt of an acid, the base polymer containing acid and or anhydride groups, and a resin with acid or phenolic groups. Examples of metal derivatives include but are not limited to calcium oxide, magnesium oxide, zinc oxide, calcium stearate, zinc stearate, zinc acetate, lithium methoxide, sodium methoxide, and the like. The metal derivative must be capable of forming ionic bonds with the anhydride or acid groups on the base polymer or with the acid or phenolic groups on the resin. The metal derivatives include but are not limited to compounds containing positive valent ions of Groups IA, IB, IIA, IIB, IIIA, IIIB and VIII of the Periodic Table of Elements. These metal ions can be complexed or uncomplexed, and can be used alone or in any mixtures thereof. Suitable monovalent metal ions are Na+, K+, Li+ among others. Suitable divalent metal ions are Mg++, Ca++, Zn++ among others. Suitable trivalent metal irons are Al+++, Sc+++ among others. Preferable compounds are hydroxides, oxides, alcoholates, carboxylates, formates, acetates, methoxides, ethoxides, nitrates, carbonates, and bicarbonates of the above referenced metal ions. See generally U.S. Pat. No. 5,516,831, col. 6, lines 8-22 for a more complete listing of metal ions, which disclosure is herein incorporated by reference.

The contact adhesive composition may have a total solids content of from 10 to 70% by weight, preferably from 15 to 55% by weight and more preferably from 20 to 50% by weight (note block copolymers will have lower viscosity than chloroprene so can be used at higher solids).

### Solvent Based Adhesives, Sealants and Coatings

In one aspect of the present invention we have discovered a novel adhesive composition comprising 100 parts by weight of at least one hybrid block copolymer, 25 to 300 parts by weight of at least one tackifying resin, 0 to 200 parts by weight of an extender oil and a solvent or solvent mixture.

One of the components used in the adhesives and sealants of the present invention is a tackifying resin. Tackifying resins include both polystyrene block compatible resins and mid block compatible resins. The polystyrene block compatible resin may be selected from the group consisting of coumarone-indene resin, polyindene resin, poly(methyl indene) resin, polystyrene resin, vinyltoluene-alphamethylstyrene resin, alphamethylstyrene resin and polyphenylene ether, in particular poly(2,6-dimethyl-1,4-phenylene ether). Such resins are e.g. sold under the trademarks “HERCURES”, “ENDEX”, “KRISTALEX”, “NEVCHEM” and “PICCOTEX”. Resins compatible with the hydrogenated (mid) block may be selected from the group consisting of compatible C₅ hydrocarbon resins, hydrogenated C₅ hydrocarbon resins, styrenated C₅ resins, C₅/C₉ resins, styrenated terpene resins, fully hydrogenated or partially hydrogenated C₉ hydrocarbon resins, rosins esters, rosin derivatives and mixtures thereof. These resins are e.g. sold under the trademarks “REGALITE”, “REGALREZ”, “ESCOREZ”, “WINGTACK” and “ARKON”.

Another one of the components used in the adhesives and sealants of the present invention is a polymer extending oil or plasticizer. Especially preferred are the types of oils that are compatible with the elastomeric segment of the block copolymer. While oils of higher aromatics content are satisfactory, those petroleum-based white oils having low volatility and less than 50% aromatic content are preferred. Such oils include both paraffinic and naphthenic oils. The oils should additionally have low volatility, preferable having an initial boiling point above about 500° F.

Examples of alternative plasticizers which may be used in the present invention are oligomers of randomly or sequentially polymerized styrene and conjugated diene, oligomers of conjugated diene, such as butadiene or isoprene, liquid polybutene-1, and ethylene-propylene-diene rubber, all having a weight average molecular weight in the range from 300 to 35,000, preferable less than about 25,000 mol weight.

The amount of oil or plasticizer employed varies from about 0 to about 300 parts by weight per hundred parts by weight rubber, or block copolymer, preferably about 20 to about 150 parts by weight.

Adhesives are formulated to give a satisfactory balance of tack, peel, shear and viscosity. Various types of fillers and pigments can be included in the adhesive formulations to pigment the adhesive and reduce cost. Suitable fillers include calcium carbonate, clay, talc, silica, zinc oxide, titanium dioxide and the like. The amount of filler usually is in the range of 0 to 30% weight based on the solvent free portion of the formulation, depending on the type of filler used and the application for which the adhesive is intended. An especially preferred filler is titanium dioxide.

If the adhesive is to be applied from solvent solution, the organic portion of the formulation will be dissolved in a solvent or blend of solvents. Aromatic hydrocarbon solvents such as toluene, xylene or Shell Cyclo Sol 53 are suitable. Aliphatic hydrocarbon solvents such as hexane, naphtha or mineral spirits may also be used. If desired, a solvent blend consisting of a hydrocarbon solvent with a polar solvent can be used. Suitable polar solvents include esters such as isopropyl acetate, ketones such as methyl isobutyl ketone, and alcohols such as isopropyl alcohol. The amount of polar solvent used depends on the particular polar solvent chosen and on the structure of the particular polymer used in the formulation. Usually, the amount of polar solvent used is between 0 and 50% wt in the solvent blend.

The compositions of the present invention may be modified further with the addition of other polymers, oils, fillers, reinforcements, antioxidants, stabilizers, fire retardants, anti blocking agents, lubricants and other rubber and plastic compounding ingredients without departing from the scope of this invention. Such components are disclosed in various patents including U.S. Pat. No. 3,239,478; and U.S. Pat. No. 5,777,043, the disclosures of which are incorporated by reference.

The compositions of the present invention may be designed for a wide variety of uses and applications. They may be applied to paper, paper boards, wood, metal foils, polyolefin films, polyvinyl chloride films, cellophane, felts, woven fabrics, non-woven fabrics, glass, etc., and for bonding two or more of such materials together. The adhesives are useful in pressure sensitive tapes, such as masking tapes, adhesive sheets, primers for other adhesives, adhesive tapes, mending tapes, electrical insulation tape, laminates, hot-melt adhesives, mastics, cements, caulking compounds, binders, sealants, delayed tack adhesives, adhesive lattices, carpet backing, cements, etc.

Regarding the relative amounts of the various ingredients, this will depend in part upon the particular end use and on the particular block copolymer that is selected for the particular end use. Table A below shows some notional compositions that are included in the present invention.

TABLE A
Applications, Compositions and Ranges

| | | Composition, |
|---|---|---|
| Application | Ingredients | Parts by weight |
| Adhesive | Hybrid Polymer | 100 |
| | Tackifying Resin | 25 to 300 |
| | Extending Oil | 0 to 200 |
| Solvent based adhesive | Hybrid Polymer | 100 |
| (not including solvent) | Tackifying Resin | 25 to 300 |
| | Oil | 0 to 100 |
| Construction adhesive or | Hybrid Polymer | 100 |
| sealant | Tackifying Resin | 0 to 200 |
| | Endblock Resin | 0 to 200 |
| | Calcium Carbonate | 0 to 800 |

### Epoxy, Urethane, and Melamine

The hybrid block copolymers of the present invention can be prepared by reaction of the base polymer with monomers and resins containing epoxy or isocyanate functional groups or amino resins containing active methylol functional groups. For example, one can prepare adhesive or coating compositions comprising a base block copolymer and an epoxy resin, an isocyanate or an amino resin in which the resin has reacted with the anhydride and/or acid groups of the base polymer. The hybrid block copolymer of the present invention which has been reacted with these resins is expected to find uses on wood, concrete, metal and plastic substrates as adhesives or as protective and decorative coatings. The relative amounts of the various ingredients will depend on the specific use but generally the ratio of block copolymer to resin or monomer will vary from 1:20 to 20:1 and more preferably from 1:10 to 10:1. Also, additional ingredients can be added the formulation including the tackifying resins, oils, plasticizers, fillers, reinforcements, antioxidants, stabilizers, fire retardants, anti blocking agents, and lubricants disclosed in the section above on solvent based adhesives.

### Acrylic Pressure-Sensitive Adhesives

The acrylic pressure-sensitive adhesive polymer of the invention is a rubber-acrylic polymer comprising an acrylic polymer backbone grafted with a particular functionalized block copolymer. Pressure sensitive acrylic adhesives are typically made by solution and emulsion polymerization. More specifically, acrylic polymer backbone contemplated for use in the practice of the invention is formed of acrylate monomers of one or more low Tg alkyl acrylates. Low transition temperature monomers are those having a Tg of less than about 0° C. Preferred alkyl acrylates which may be used to practice the invention have up to about 18 carbon atoms in the alkyl group, preferably from about 4 to about 10 carbon atoms in the alkyl group. Alkyl acrylates for use in the invention include butyl acrylate, amyl acrylate, hexyl acrylate, 2-ethylhexyl acrylate, isooctyl acrylate, decyl acrylate, dodecyl acrylates, isomers thereof, and combinations thereof. A preferred alkyl acrylate for use in the practice of the invention is 2-ethyl hexyl acrylate.

The monomer system used to make the acrylic backbone polymer could be solely based on low Tg alkyl acrylate ester monomers, but is preferably modified by inclusion of high Tg monomers and/or functional comonomers, in particular carboxy-containing functional monomers, and/or, even more preferably, hydroxy-containing functional monomers.

High Tg monomer components which may be present, and in some embodiments are preferably present, include methyl acrylate, ethyl acrylate, isobutyl methacrylate, and/or vinyl acetate. The high Tg monomers may be present in a total amount of up to about 50% by weight, preferably from about 5 to about 50% by weight, even more preferably from about 10 to about 40% by weight, based on total weight of the hybrid polymer.

The acrylic backbone polymer may also comprise one or more functional monomers. Preferred are carboxy and/or hydroxy functional monomers. This may be added to the base polymer to make the functionalized block copolymer, or the base polymer may be added separately, and the functional monomers added with the acrylic monomers.

Carboxy functional monomers will typically be present in the hybrid polymer in an amount of up to about 7% by weight, more typically from about 1 to about 5% by weight, based on the total weight of the monomers. Useful carboxylic acids preferably contain from about 3 to about 5 carbon atoms and include, among others, acrylic acid, methacrylic acid, itaconic acid, and the like. Acrylic acid, methacrylic acid and mixtures thereof are preferred.

In a particularly preferred embodiment, the acrylic backbone comprises hydroxy functional monomers such as hydroxyalkyl(meth)acrylate esters, and acrylic polymers used to form the backbone of the invention are preferably acrylic ester/hydroxy(meth)alkyl ester copolymers. Specific examples of hydroxy functional monomers include hydroxyethyl acrylate, hydroxypropyl acrylate, hydroxyethyl methacrylate and hydroxypropyl methacrylate. Hydroxy functional monomers are generally used in an amount of from about 1 to about 10%, preferably from about 3 to about 7%.

Other comonomers can be used to modify the Tg of the acrylic polymer, to further enhance adhesion to various surfaces and/or to further enhance high temperature shear properties. Such comonomers include N-vinyl pyrrolidone, N-vinyl caprolactam, N-alkyl(meth)acrylamides such as t-octyl acrylamide, cyanoethylacrylates, diacetoneacrylamide, N-vinyl acetamide, N-vinyl formamide, glycidyl methacrylate and allyl glycidyl ether, methyl methacrylate, acrylonitrile, and styrene.

The monomer proportions of the acrylic polymer are adjusted in such a way that the backbone polymer has a glass transition temperature of less than about −10° C., preferably from about −20° C. to about −60° C.

The preferred pressure sensitive adhesive compositions are preferably crosslinked using a chemical crosslinking agent. While the use of aluminum and titanium crosslinking agents may be used to practice the invention, it has been discovered that use of titanium containing metal alkoxide crosslinker is necessary for high temperature performance, and is the preferred crosslinker for hydroxyalkyl(meth)acrylate esters. The use of a titanium crosslinker imparts a yellowish color to the final product but, for many applications, is of little concern. The crosslinker is typically added in an amount of from about 0.3% to about 2% by weight of the hybrid polymer.

The pressure sensitive adhesive compositions of this invention are preferably tackified. The acrylic and rubber components of the hybrid polymer are believed to form a microphase separated structure in the solid state. Support for this comes from the appearance of two distinct glass transition temperatures revealed by the dynamic mechanical analysis of the adhesive composition. Tackifying resins useful in these compositions are compatible with the rubber macromer phase. Tackifiers compatible with the acrylic phase can, of course, be used with any acrylic polymer and the hybrid polymer of this invention is no exception. However, such tackifiers are typically derived from natural rosin and are associated with poor aging characteristics. It is an objective of this invention to overcome these problems. Thus the preferred tackifiers are synthetic hydrocarbon resins derived from petroleum. Non-limiting examples of rubber phase associating resins include aliphatic olefin derived resins such as those available from Goodyear under the Wingtack® and the Escorez® 1300 series from Exxon. A common C5 tackifying resin in this class is a diene-olefin copolymer of piperylene and 2-methyl-2-butene having a softening point of about 95° C. This resin is available commercially under the tradename Wingtack 95. The resins normally have ring and ball softening points as determined by ASTM method E28 between about 20° C. and 150° C. Also useful are C9 aromatic/aliphatic olefin-derived resins available from Exxon in the Escorez 2000 series. Hydrogenated hydrocarbon resins are especially useful when the long term resistance to oxidation and ultraviolet light exposure is required. These hydrogenated resins include such resins as the Escorez 5000 series of hydrogenated cycloaliphatic resins from Exxon, hydrogenated C9 and/or C5 resins such as Arkon® P series of resins by Arakawa Chemical, hydrogenated aromatic hydrocarbon resins such as Regalrez® 1018, 1085 and the Regalite® R series of resins from Hercules Specialty Chemicals. Other useful resins include hydrogenated polyterpenes such as Clearon® P-105, P-115 and P-125 from the Yasuhara Yushi Kogyo Company of Japan.

The tackifying resin will normally be present at a level of 5 to 50% by weight of the adhesive composition and preferably at a level of about 10 to 40% by weight of the adhesive composition.

The formulated adhesive may also include excipients, diluents, emollients, plasticizers, antioxidants, anti-irritants, opacifiers, fillers, such as clay and silica, pigments and mixtures thereof, preservatives, as well as other components or additives.

The pressure sensitive adhesives of the invention may advantageously be used in the manufacture of adhesive articles including, but not limited to, industrial tapes and transfer films. The adhesive articles are useful over a wide temperature range, have improved UV resistance and adhere to a wide variety of substrates, including low energy surfaces, such as polyolefins, e.g., polyethylene and polypropylene, polyvinyl fluoride, ethylene vinyl acetate, acetal, polystyrene, powder-coated paints, and the like. Single and double face tapes, as well as supported and unsupported free films are encompassed by the invention. Also included, without limitation, are labels, decals, name plates, decorative and reflective materials, reclosable fasteners, theft prevention and anti-counterfeit devices.

In one embodiment, the adhesive article comprises an adhesive coated on at least one major surface of a backing having a first and second major surface. Useful backing substrates include, but are not limited to foam, metal, fabric, and various polymer films such as polypropylene, polyamide and polyester. The adhesive may be present on one or both surfaces of the backing. When the adhesive is coated on both surfaces of the backing, the adhesive on each surface can be the same or different.

### Structural Acrylic Adhesives

Structural acrylic adhesives are well known for bonding a wide variety of substrates. They are used as an alternative to mechanical joining methods for a number of reasons including cost, aesthetics, and noise reduction. The disclosed structural adhesive compositions comprise at least two components. The first or monomer component of the composition may have several sub-components including a methacrylate ester monomer, additional monomers and at least one elastomeric material. The monomer component may also include, inter alia, adhesion promoters, cross-linked rubbers, tertiary amine initiators, inhibitors, open-time promoters, thixotropic agents, antioxidants, plasticizers, talc and cohesive failure mode promoters. The second or catalyst component of the composition includes a polymerization catalyst.

The methacrylate ester monomers include those where the alcohol portion of the ester group contains one to eight carbon atoms. Examples of such ester monomers are methyl methacrylate (MMA), ethyl methacrylate, 2-ethyhexyl methacrylate, cyclo-10 hexyl methacrylate, lauryl methacrylate and mixtures thereof. The methacrylate ester monomers also include less volatile monofunctional methacrylates such as tetrahydrofurfuryl and hydroxyethyl esters. The preferred ester monomers are MMA, tetrahydrofurfuryl methacrylate and lauryl methacrylate

Additional monomers which may be used in combination with the methacrylate ester monomers are acrylate esters wherein the alcohol portion of the ester contains one to eight carbon atoms, examples of which are methyl acrylate, ethyl acrylate, butyl acrylate and 2-ethyhexyl acrylate. Other useful monomers are acrylonitrile, methacrylonitrile, styrene, vinyl toluene, and the like.

Other additional monomers which may be used in combination with the methacrylate ester monomers are polymerizable ethylenically unsaturated mono or polycarboxylic acids. Acrylic acid, methacrylic acid (MAA), isophthalic acid (EPA), crotonic acid, maleic acid and fumaric acid are examples of such acids. The preferred acids are MAA or IPA.

The elastomeric material used in these structural adhesive compositions is the hybrid block copolymer of the present invention. Preferably, the hybrid block copolymer is a reaction product of the base block copolymer with anhydride and acid groups with a multifunctional monomer which contains both a functional group that reacts with the anhydride or acid group of the base polymer and a functional group that will react with the monomer component of the structural adhesive in a free radical process. The latter functional group is preferably either an acrylate or methacrylate double bond. Examples of the multifunctional monomer include but are not limited to glycidyl acrylate, glycidyl methacrylate, hydroxy ethyl acrylate and hydroxy ethyl methacrylate.

The tertiary amine initiator helps accelerate the reaction of the methacrylate ester monomers with the polymerization catalyst and is selected from N,N-dimethylaniline, N,N-dimethyltoluidine (DMT), N,N-diethylaniline, N,N-diethyltoluidine, N,N-bis[dihydroxyethyl]-p-toluidine, N,N-bis[dihydroxypropyl]-p-toluidine and the like.

While any order may be utilized for the addition of sub-components of the monomer component, the preferred order is as follows. To the elastomer solution(s), the cohesive failure mode promoter solution is added, if present. Then the remaining neat methacrylate ester monomer is added, followed by the plasticizer, the adhesion promoter, the open time promoter, the antioxidant, the inhibitor, the additional monomers, and the tertiary amine initiator. All sub-components are not necessarily included in each monomer component. The included sub-components are mixed. Next, the talc, and the cross-linked rubber are added while slowly increasing the mixing speed. Next, the thixotropic agent is added and mixing is continued. The mixing machine is stopped and the mixture is allowed to sit. To insure that the thixotropic agent is properly activated and to insure that the cross-linked rubber is fully swelled, the mixture may be mixed and allowed to sit repeatedly. After it is allowed to sit, the mixture is mixed to create a uniform consistency. Finally, the mixture is mixed under a vacuum to remove any entrapped air. Generally, the amount of the methacrylate ester monomer may be increased to compensate for losses attributed to the application of the vacuum.

The catalyst component of the composition is a polymerization catalyst. Suitable catalysts include free radical generators which trigger the polymerization of the monomer component. Such catalysts are peroxides, hydroperoxides, peresters, and peracids. Examples of these catalysts are benzoyl peroxide, cumene hydroperoxide, tertiary butyl hydroperoxide, dicumyl peroxide, tertiary butyl peroxide acetate, tertiary butyl perbenzoate, ditertiary butyl azodiisobutyronitrile and the like. Radiant energy, e.g., ultraviolet light, and heat, may also be used as a catalyst. The preferred catalyst is a paste of 18 wt % anhydrous benzoyl peroxide.

The total elastomer content will be 5-50% to ensure toughness and flexibility. The hybrid polymer can be combined with other elastomers to make up the total elastomer content. Preferably the hybrid polymer is added at 5-20% to ensure low viscosity.

### Acrylic Sealants and Coatings

Acrylic sealants and coatings comprise the elastomeric block copolymers of the present invention, an acrylic ester and a monomer which gives flexibility. Typically hard acrylic esters like methyl methacrylate, vinyl acetate, and methyl acrylate are used in combination with monomers which give flexibility including butyl acrylate and 2-ethylhexyl acrylate.

### Radiation Cured Adhesives, Sealants, Coatings and Printing Plates

The base polymers of the present invention can be converted to radiation curable polymers simply by reaction with a monomer which contains both a functional group that reacts with the anhydride or acid group of the base polymer and a functional group that is radiation curable, for example an acrylic, epoxy or thiol moiety. Examples of such monomers include but are not limited to glycidyl acrylate, glycidyl methacrylate, hydroxy ethyl acrylate and hydroxy ethyl methacrylate. These reaction products are hybrid block polymers which are radiation curable and can be used to formulate adhesives, sealants, coatings and printing plates both from solution, hot melt, and from water based dispersions. They can be used as the primary ingredient in the formulation or can be used as an additive in the formulation. The formulations are similar to non radiation cured adhesives, sealants and coatings except that they also contain initiators that react after irradiation, and can also contain other monomers, oils, resins, and polymers that react though the radiation initiated chemistry.

In UV cure, for example, a photoinitiator is included in the formulation. It is also possible to employ electron beam curing. Also, multifunctional monomers such as di and tri acrylates can be added to the formulation to improve and speed the cure. For example, the hybrid polymer with acrylic functionality can be mixed with an acrylic monomer and initiator, processed into an adhesive, sealant, coating or printing plate, and then cured via radiation. The hybrid radiation curable polymer is combined with a photoinitiator, optionally a multifunctional acrylic monomer, optionally other radiation curable monomers and polymers such as non-hydrogenated and selectively hydrogenated styrenic block copolymers, optionally other radiation curable plasticizers and resins such as liquid polybutadiene and polyisoprene oils, and optionally other formulating ingredients such as the tackifying resins, oils, plasticizers, fillers, reinforcements, antioxidants, stabilizers, fire retardants, anti blocking agents, and lubricants disclosed in the section above on solvent based adhesives.

### Melt Processes and Water Based Processes

It is often desirable to carry out processes in the melt so that costly solvent or water removal steps can be avoided. The hybrid polymers of the present invention can be prepared in solvent, water based emulsions and dispersions, and melt processes by methods well known in the art. For example, an acrylic copolymer with reactive functional groups can be mixed with the base block copolymer with acid or anhydride groups in a batch mixer or extruder prior to or during preparation of the adhesive, sealant or coating. Other formulating ingredients can be present or added during the mixing process. For example, an acrylic or epoxy monomer or a melamine resin or a metal derivative can be reacted with the base block copolymer with acid or anhydride groups in a batch mixer or extruder. The reaction of the starting block copolymer with TBMA endblocks to form the base block copolymer with acid or anhydride groups can be done in the same melt process step in which the reaction with reactive monomer, resin or metal derivative occurs.

Water based processes are also of interest because of environmental restrictions on solvent emissions and because water based emulsions and dispersions have low viscosity. The base block copolymer with acid or anhydride groups can be added to reactive monomers or resins or metal derivatives, and this mixture dispersed or emulsified in water so that the hybrid block copolymer is formed in a water based system or after application and further treatment of the water based product. Alternatively the hybrid block copolymer can be prepared and then formulated and this formulation can be dispersed or emulsified in water.

### EXAMPLES

The following examples are provided to illustrate the present invention. The examples are not intended to limit the scope of the present invention and they should not be so interpreted. Amounts are in weight parts or weight percentages unless otherwise indicated.

### Example 1

### Preparation of Block Copolymers: Polymer #1 Polymer #2 Polymer #3

Polymer #1 was polymerized in the solvent mixture comprising 90% cyclohexane and 10% diethyl ether. Styrene was polymerized in the step I reactor and the living polymer was transferred to the step II reactor for sequential polymerization of butadiene followed by tert-butyl methacrylate (“TBMA”). The polymerization was terminated with methanol. 1.61 kg of TBMA and 37.5 kg of total monomer were charged for a target polymer TBMA content of 4.3% wt. The peak molecular weights in polystyrene equivalents were characterized by GPC with UV detector at each step: 7,054 after styrene polymerization, 122,425 after BD polymerization, and a mixture of 67% of a material with 127,043 molecular weight and 33% of a species with 250,264 molecular weight after TBMA polymerization. The reaction mixture was analyzed by NMR after TBMA polymerization and shown to contain no unreacted monomer within detection limits. The polymer was hydrogenated with a cobalt catalyst, washed with dilute phosphoric acid, neutralized with ammonia and stabilized with 0.1% Irganox 1010. The hydrogenated polymer cement was analyzed by NMR. The hydrogenated polymer contained 9.5% styrene, a residual unsaturation of 0.12 meq/gm, and a 1,2 BD content of 39.6%. The S-EB-TBMA polymer was recovered by cyclone finishing and dried in an air circulating oven.

Polymer #2 was polymerized in the solvent 90% cyclohexane/10% diethyl ether. Styrene was polymerized in the step I reactor and the living polymer was transferred to the step II reactor for sequential polymerization of butadiene followed by TBMA. The polymerization was terminated with methanol. 3.08 kg of TBMA and 37.5 kg of total monomer were charged for a target polymer TBMA content of 8.2% wt. The peak molecular weights in polystyrene equivalents were characterized by GPC with UV detector at each step: 7,117 after styrene polymerization, 127,360 after BD polymerization, and a mixture of 66% of a material with 130,562 molecular weight and 34% of a species with 256,135 molecular weight after TBMA polymerization. The reaction mixture was analyzed by NMR after TBMA polymerization and shown to contain no unreacted monomer within detection limits. The polymer was hydrogenated with a cobalt catalyst, washed with dilute phosphoric acid, neutralized with ammonia and stabilized with 0.1% Irganox 1010. The hydrogenated polymer cement was analyzed by NMR. The hydrogenated polymer contained 9.2% styrene, a residual unsaturation of 0.20 meq/gm, and a 1,2 BD content of 39.5%. The S-EB-TBMA polymer was recovered by cyclone finishing and dried in an air circulating oven.

Polymer #3 was prepared by sequential polymerization in 90% cyclohexane/10% diethyl ether of 30 kg of butadiene followed by 7.5 kg of TBMA. The polymerization was terminated with methanol. The target polymer TBMA content was 20%. The peak molecular weights in polystyrene equivalents were characterized by GPC with refractive index detector at each step: 113,106 after BD polymerization and a mixture of 62% of a material with 116,479 molecular weight and 38% of a species with 226,980 molecular weight after TBMA polymerization. The polymer was hydrogenated with a cobalt catalyst, washed with dilute phosphoric acid, neutralized with ammonia and stabilized with 0.1% Irganox 1010. The EB-TBMA polymer was recovered by hot water coagulation.

### Conversion of Block Copolymers to Anhydride Form

The polymers were converted to the anhydride/acid form by extruding with a Berstoff 25 mm twin screw co-rotating extruder. Two examples are given below:

### Extruder Conditions

| Actual | | |
|---|---|---|
| temperature ° C. | POLYMER #1A | POLYMER #1B |
| Zone 1 | 250 | 220 |
| Zone 2 | 250 | 220 |
| Zone 3 | 255 | 225 |
| Zone 4 | 255 | 225 |
| Zone 5 | 260 | 230 |
| Zone 6 | 260 | 230 |
| Zone 7 | 260 | 230 |
| Extruder | 200 | 198 |
| speed rpm | | |

IR spectroscopy showed that the S-EB-MAAn polymers were substantially converted from the TBMA ester to the TBMA anhydride form. Polymer #1 has an IR absorption peak at about 1726 cm⁻¹ which is characteristic of the ester group. After extrusion, Polymer #1A and Polymer #1B have virtually no peak at 1726 cm⁻¹ and have IR absorption peaks at about 1800 cm⁻¹ and 1760 cm⁻¹. These are characteristic peaks for the anhydride group.

### Example 1a

Polymer #4 is an S-EB-TBMA triblock copolymer with a polystyrene block molecular weight of 6,695 (Molecular weight is measured according to the method in Example 1, peak molecular weights in polystyrene equivalents characterized by GPC). The S-EB block molecular weight of 99,184 and the peak molecular weight of the full molecule with the TBMA is 102,800. The TBMA content is about 13 wt % and the polystyrene content is 9 wt %. The GPC analysis revealed 31% of a species with 250,264 molecular weight after TBMA polymerization.

### Prophetic Example 2

### Toughened Epoxy Composition

270 grams of aromatic epoxy resin, the diglycidyl ether of bis phenol A, having an epoxide equivalent weight of 190 (Epon 828 from Hexion) is heated to 130° C. in a 400 ml beaker on a hot plate. 30 grams of S-EB-MAAn (extruded Polymer #2) is mixed in using a Silverson Model L2Air high shear mixer. After the polymer is mixed in to the resin, the temperature is raised to 190° C. and mixing is continued for 30 minutes. This rubber modified epoxy resin at room temperature is a hazy, thick liquid.

90 grams of the rubber modified epoxy resin is mixed with 10 grams of toluene. This is mixed with 130 grams of an aliphatic polyamine adduct having an amine equivalent weight of 200 (Curing Agent C111 from Hexion). The composition is coated onto a steel panel. After one week cure at room temperature, the composition is a coating having good impact resistance.

### Prophetic Example 3

### Ambient Cure Urethane Compositions

16.7 grams of S-EB-MAA (extruded Polymer #2+atmospheric moisture) having an acid equivalent weight of 1670 is dissolved in 150 grams of toluene (10% w solids). 4.05 grams of aromatic polyisocyanate having an NCO equivalent weight of 405 (Mondur CB-60 from Bayer) is added, making a composition at 1/1 NCO/COOH. After mixing 1 hour on a shaker, the composition is coated onto a steel panel. After one week cure at room temperature, the composition is a polyurethane coating.

16.7 grams of S-EB-MAA (extruded Polymer #2+atmospheric moisture) having an acid equivalent weight of 1670 is dissolved in 150 grams of toluene (10% w solids). 3.65 grams of aliphatic polyisocyanate having an NCO equivalent weight of 365 (Vestanat T 1890 L from Degussa) is added, making a composition at 1/1 NCO/COOH, and 0.2 grams of dibutyl tin dilaurate (DBTDL) is added. After mixing 1 hour on a shaker, the composition is coated onto a steel panel. After one week cure at room temperature, the composition is a polyurethane coating.

16.7 grams of S-EB-MAA (extruded Polymer #2+atmospheric moisture) having an acid equivalent weight of 1670 is dissolved in 150 grams of toluene (10% w solids). 10.95 grams of aliphatic polyisocyanate having an NCO equivalent weight of 365 (Vestanat T 1890 L) is added, making a composition at 3/1 NCO/COOH, and 0.6 grams of dibutyl tin dilaurate (DBTDL) is added. After mixing 1 hour on a shaker, the composition is coated onto a steel panel. After one week cure at room temperature, the composition is a polyurethane/polyurea coating.

### Prophetic Example 4

### Bake Cure Compositions

16.7 grams of S-EB-MAA (extruded Polymer #2+atmospheric moisture) having an acid equivalent weight of 1670 is dissolved in 150 grams of toluene (10% w solids). 9.3 grams of blocked aliphatic polyisocyanate having an NCO equivalent weight of 930 (Desmodur BL-1260A from Bayer) is added, making a composition at 1/1 NCO/COOH, and 0.2 grams of dibutyl tin dilaurate (DBTDL) is added. After mixing 1 hour on a shaker, the composition is coated onto a steel panel. The coated panel is baked 20 minutes at 160° C. to give a composition which is a polyurethane coating.

9.0 grams of S-EB-TBMA (Polymer #2) is dissolved in 90 grams of toluene (10% w solids). 1.0 gram of hexamethoxy melamine resin (Cymel 303 from Cytec) and 0.02 grams of dodecyl benzene sulfonic acid (Cycat 600 from Cytec) is added. After mixing 1 hour on a shaker, the composition is coated onto a steel panel. The coated panel is baked 10 minutes at 190° C. to give a composition which is a melamine cured coating.

### Prophetic Example 5

### Contact Adhesives

100 grams of S-EB-MAA (extruded Polymer #1+atmospheric moisture) are added to the following formulations by mixing in a jar on a lab roller mixer:

| Component | #1 | #2 | #3 | #4 | #6 |
|---|---|---|---|---|---|
| Parts by Weight | | | | | |
| Extruded 9207 | 100 | 100 | 100 | 100 | 100 |
| Schenectady SP-154 | 40 | | | | 40 |
| Magnesium Oxide (a) | 10 | | | | |
| Aluminum acetyl acetonate(a) | | | | | 10 |
| Cymel 303 | | 40 | | | |
| Cycat 600 | | 4 | | | |
| Piccotac 5140 | | | 40 | | |
| SA120M low mwt PPE | | | | 40 | |
| Pentalyn HE | | | 10 | 10 | |
| Irg 1010 phenolic AO | 2 | 2 | 2 | 2 | 2 |
| Solvent Blend | 608 | 584 | 608 | 608 | 608 |

(a) Magnesium oxide and AlAcAc are added to the formulations as masterbatchs, i.e. as 10% solids dispersions in toluene. The best results are obtained by further homogenizing formulations which contain an inorganic solid such as magnesium oxide and AlAcAc. This can be accomplished with mixers such as a Silverson Model L2Air high shear mixer, mixers with vertical and horizontal blades such as those produced by the Jiffy Mixer Co., and even simple propeller mixers used to homogenize paints.

Here, Schenectady SP-154 is a mixed alkyl phenol heat reactive resin with melting point of about 80° C. supplied by the SI Group, Cymel 303 is a hexamethoxymelamine resin supplied by Cytec. Cycat 600 is dodecylbenzene sulfonic acid supplied from Cytec. Picco 5140 is an aromatic resin with softening point 141° C. supplied by Eastman. Pentalyn HE is an ester of hydrogenated rosin supplied by Eastman. SA120M is a low molecular weight polyphenylene ether supplied by General Electric.

These compositions are coated onto test substrates of particle board and laminate (Formica) at a dry coat weight of about 2.5 gm/ft². They are also coated onto canvas with two coats so that a uniform coat is produced. The coated substrates and canvas are allowed to dry for 24 hours before either bonding or putting a second coat onto the canvas. After the coated substrates and canvas are dried, they are pressed together with a Carver press at 35 psi and 160° C. to form 180° peel samples (canvas to particle board) and lap shear strength samples of particle board to laminate. These solvent based contact adhesive formulations exhibit low viscosity, good adhesion to a variety of substrates, and good cohesive strength at elevated temperature.

### Prophetic Example Example 6

### Preparation of Macromonomer

The reaction was carried out in a 3-neck, 1 liter glass round bottom flask equipped with a motorized stirrer, water condenser and nitrogen inlet/outlet and addition funnel. An amount of S-EB-TBMA that was previously converted quantitatively to the anhydride/acid form (see Example 1) was dissolved in toluene to give a 10 wt % solution. To this polymer solution was added glycidyl methacrylate (“GMA”) and tri-isobutyl amine as catalyst. An initial sample was removed for NMR analysis.

The reaction mixture was then heated to reflux (approximately 100° C.) and stirred under a nitrogen flow for one hour. After cooling to ambient temperature, a second sample was removed for NMR analysis. The ratio of unreacted epoxy to opened epoxy was used as a measure of reaction yield. The yield was determined using proton NMR. The macromonomer could be isolated and purified from any unreacted GMA. However, the unpurified macromonomer can be used directly for a copolymerization with other acrylic monomers to form the hybrid adhesive. Any unreacted GMA will copolymerize as outlined in the next step of Example 7.

### Prophetic Example 7

### Preparation of the Hybrid Acrylic Pressure-Sensitive Adhesive via Copolymerization of Macromonomer with Acrylic Monomer

The reaction was carried out in the same 3-neck, 1 liter glass round bottom flask that contained the macromonomer as described in Example 6 above. 2-ethylhexyl acrylate, ethylacetate and hexane were added to the preexisting macromonomer/toluene solution. 2,2′-azobisisobutyronitrile (AIBN) dissolved in hexane was then added. The reaction mixture was slowly heated to reflux and stirred for two hours. After cooling, the reaction mixture was precipitated in methanol to aid in the removal of any unreacted monomers. The resultant solid copolymer was a tacky white solid.

### Working Example 6a

### Preparation of Macromonomer

The reaction was carried out in a 3-neck, 1 liter glass round bottom flask equipped with a motorized stirrer, water condenser, nitrogen inlet/outlet and addition funnel. 1.0 gram of block copolymer Polymer #4 (anhydride form, converted in an extruder), 3.0 grams 2-hydroxy ethylacrylate, 11.0 g cyclohexane and 3.0 g ethyl acetate were combined and stirred at room temperature to dissolve the block copolymer. The temperature was raised to about 80° C. (reflux point) and the reaction mixture was stirred for 4 hours. FT-IR confirmed the addition of some of the 2HEA monomer as evident by the growth of the carboxylic acid band at 1705 cm⁻¹.

### Working Example 7a

### Preparation of the Hybrid Acrylic Pressure-Sensitive Adhesive via Copolymerization of Macromonomer with Acrylic Monomer

To the cooled reaction mixture of example 6 was added 17 grams of n-butyl acrylate and 0.05 gram AIBN initiator. The mixture was again brought to reflux for 2 hours for the free radical copolymerization. The bulk macromonomer solution was cooled back to room temperature and 1 gram of Regalrez 1018, 2 grams of Regalrez 1085, 0.5 grams Drakeol 34 and 54 grams of toluene was added and stirred to make a homogeneous solution. This mixture was used directly for the 180 degree peel tests.

### Adhesion Data

The formulated macromonomer-based adhesive of example 7 gave an improved peel value of 1.1 pli to the polyethylene panel;

Those skilled in the art would know that many variations of this macromonomer approach could be envisioned. For example, the functional acrylic monomer could contain a number of other reactive moieties capable of reacting with the glutaric anhydride such as epoxies (glycidyl acrylates), isocyanates and/or carboxylic acids (acrylic or methacrylic acid that form hydrogen bonds with the anhydride).

### Prophetic Example 8

### Preparation of Comparative Control

In this example, a homopolymer of 2-ethylhexyl acrylate was prepared without the macromonomer. The reaction was carried out in a 3-neck, 1 liter glass round bottom flask equipped with a motorized stirrer, water condenser and nitrogen inlet/outlet and addition funnel. N-hexyl acrylate, ethylacetate and hexane were added to the flask. AIBN dissolved in hexane was then added. The reaction mixture was slowly heated to reflux and stirred for two hours. The viscosity of the reaction mixture has clearly increased. After cooling, the reaction mixture was precipitated in methanol to aid in the removal of any unreacted monomers.

### Working Example 8a

### Preparation of Comparative Control

In this example, a homopolymer of n-butyl acrylate was prepared without the macromonomer and used as the control for 180 degree peel measurement shown in Example 7. The reaction was carried out in a 3-neck, 1 liter glass round bottom flask equipped with a motorized stirrer, water condenser and nitrogen inlet/outlet and addition funnel. 30 grams N-butyl acrylate, ethylacetate and hexane were added to the flask. 25 mg of AIBN dissolved in hexane was then added. The reaction mixture was slowly heated to reflux and stirred for 5 hours. The viscosity of the reaction mixture had clearly increased. After cooling, the reaction mixture was precipitated in methanol to aid in the removal of any unreacted monomers. The isolated polymer was a sticky white solid.

### Adhesion Data

Control Peel value for unmodified poly(nbutyl acrylate) to polyethylene was measured to be 0.46 pli.

### Prophetic Example 9

### Preparation of Comparative Control

In this example the homopolymer of ethylhexyl acrylate was physically mixed with the polymer Polymer #1 using toluene as solvent. This physical blend was used to demonstrate the difference between blend and the case where the macromonomer is copolymerized with acrylic monomer to form the hybrid adhesive.

### Prophetic Example 10

### Preparation of Functional Acrylic Copolymer Containing Reactive Comonomer

The reaction was carried out in a 3-neck, 1 liter glass round bottom flask equipped with a motorized stirrer, water condenser and nitrogen inlet/outlet and addition funnel. 2-ethylhexyl acrylate, 2-hydroxyethyl acrylate, ethylacetate and hexane were added to the flask. AIBN dissolved in hexane was then added. The reaction mixture was slowly heated to reflux and stirred for two hours. The viscosity of the reaction mixture was expected to increase. After cooling, the reaction mixture was precipitated in methanol to aid in the removal of any unreacted monomers. Proton NMR is expected to reveal a copolymer that contained 2-hydroxyethyl acrylate into the copolymer.

### Working Example 10a

### Preparation of Functional Acrylic Copolymer Containing Reactive Comonomer

A copolymer of n-butyl acrylate (NBA) and 2-hydroxyl ethyl acrylate (2HEA) was prepared by free radical polymerization of 20 grams of n-butyl acrylate and 5 grams of 2-hydroxyl ethyl acrylate in ethylacetate solvent. AIBN (25 mg) was added to the reactor and the temperature was raised until the solvent was refluxing at about 66° C. The reaction was allowed to stir at reflux for 4 hours. The acrylic copolymer was isolated by precipitation in methanol/water (90/10 v/v). The precipitation solvents contained 0.1 wt % Irganox 1010 stabilizer. The copolymer was dried in a vacuum oven for 24 hours at 50° C.

Proton NMR confirmed that the copolymer contained 21.6 wt % 2HEA repeat units. GPC showed a very broad molecular weight distribution with a peak molecular weight (relative to polystyrene standard) of 50,300 g/mol. The acrylic copolymer was a sticky white solid.

### Prophetic Example 11

### Preparation of Hybrid Acrylic Pressure-Sensitive Adhesive by Reaction of the Anhydride-Functional Block Copolymer and the Hydroxyl-Functional Acrylic Copolymer

This example shows an alternative synthetic method to prepare a hybrid PSA by taking the hydroxyl functional acrylic copolymer of Example 10 and allowing these hydroxyl groups to react with the anhydride rings of the functional block copolymer via an alcoholysis reaction.

The hydroxyl-functional acrylic copolymer of Example 10 was dissolved in toluene. A separate solution of toluene and an anhydride/acid functionalized block copolymer (S-EB-MAA) was shaken until fully dissolved. The two polymer solutions were mixed together and heated to reflux for 4 hours in the reaction apparatus already described. NMR will be used to measure the disappearance of the hydroxyl group (2HEA unit) as a way to monitor the extent of reaction.

### Working Example 11

### Preparation of Hybrid Acrylic Pressure-Sensitive Adhesive by Reaction of the Anhydride-Functional Block Copolymer and the Hydroxyl-Functional Acrylic Copolymer

This example shows an alternative synthetic method to prepare a hybrid PSA by taking the hydroxyl functional acrylic copolymer of Example 10 and allowing these hydroxyl groups to react with the anhydride rings of the functional block copolymer via an alcoholysis reaction.

### Formulation A

100 phr Polymer #1 (glutaric anhydride form)
200 phr Regalrez 1085 resin (Eastman Chemical Co.)
100 phr Regalrez 1018 liquid resin (Eastman Chemical Co.)
50 phr Drakeol 34 mineral oil (Penreco)
3 phr Irganox 1010 antioxidant (Ciba Chemical Co.)
This formulation was dissolved in an 80/20 mixture of toluene/ethylacetate to afford a 20 wt % solution

In a separate reactor, the following mixture of the acrylic copolymer was prepared:

### Acrylic Copolymer Solution B

20 grams n-butyl acrylate-co-2-hydroxethyl acrylate copolymer (from Example #10)
80 grams toluene
20 grams ethyl acetate
0.2 grams Irganox 1010

The two formulations were mixed together in a 3-neck, 1 liter glass round bottom flask equipped with a motorized stirrer, water condenser, nitrogen inlet/outlet and addition funnel. The mixtures were combined such that 1 gram of formulation A was combined with 20 grams of acrylic copolymer solution B. The mixture was heated to reflux (about 85° C.) for one hour. This reaction mixture was used directly for the 180° Peel measurement against a polyethylene panel.

### Adhesion Results:

180° Peel (pli) Stainless steel: 1.93 pli
180° Peel (pli) Polyethylene: 1.43 pli

Improved adhesion was observed versus the control from working Example 10a (acrylic copolymer alone) that had an average 1800 Peel to polyethylene of 0.70 pli.

### Prophetic Example 12

### Hot Melt Preparation to Produce a Hybrid PSA

The process to produce novel hybrid acrylic pressure-sensitive adhesives with the block copolymers of this invention is not limited to solvent-based chemistries. Both the functional acrylic copolymer and the anhydride-containing block copolymers can be mixed and reacted in the solid state to form useful compositions basically equivalent to the solvent-based examples. The mixing can be accomplished in extruders, open mixers or high shear mixers.

In this example, a copolymer of n-butyl acrylate (NBA) and 2-hydroxyl ethyl acrylate (2HEA) was prepared by free radically polymerizing 20 grams of n-butyl acrylate and 5 grams of 2-hydroxyl ethyl acrylate in ethylacetate solvent. AIBN (25 mg) was added to the reactor and the temperature was raised until the solvent was refluxing at about 66° C. The reaction was allowed to stir at reflux for 4 hours. The acrylic copolymer was isolated by precipitation in methanol/water (90/10 v/v). The precipitation solvents contained 0.1 wt % Irganox 1010 stabilizer. The copolymer was dried in a vacuum oven at about 50° C.

Proton NMR confirmed that the copolymer contained about 21.6 wt % 2HEA repeat units. GPC showed a very broad molecular weight distribution with a peak molecular weight (relative to polystyrene standard) of 50,300 g/mol. The acrylic copolymer was a sticky white solid.

The anhydride form of the hybrid block copolymer Polymer #1 (1 gram) and NBA-HEA acrylic copolymer (1 gram) was dissolved in toluene/ethylacetate (90/10 v/v). A film was cast on an aluminum sheet with a release coating. The dried film of this polymeric blend was slightly opaque suggesting the two polymeric components where phase separated. This film was then compressed and heated in a Carver Press device with a temperature of 150° C. for 10 minutes to induce an alcoholysis reaction between the hydroxyl groups of the acrylic copolymer (the 2HEA units) and the glutaric anhydride of the Polymer #1 block copolymer. The resulting polymeric product was a tacky, rubbery solid with moderate tensile strength. The product was soluble in THF and the cast film was transparent suggesting the reaction had occurred to join the acrylic copolymer to the block copolymer.

Once determining that a hybrid, or graft copolymer, could be prepared between a functionalized acrylic copolymer and the anhydride containing block copolymer, a larger sample was prepared using this hot melt method. Moreover, a hydrogenated tackifying resin was added to lower the modulus of the EB rubber phase.

The 180 degree peel was measured to a polyethylene film which is a well known low surface energy substrate. Compared to the unmodified acrylic copolymer, the hybrid graft polymer (S-EB-MAA-g-NBA-2HEA) had enhanced adhesion to the LSE substrate. This example also demonstrates that hybrid adhesives can be prepared as solvent-based systems or as hot melt systems.

| | NBA-2HEA | |
|---|---|---|
| | copolymer | Hybrid Example # |
| 180° peel - substrate | | |
| (pli) to polyethylene | | |

### Working Example 12a

### Preparation of Hybrid Acrylic Pressure-Sensitive Adhesive by Reaction of the Anhydride-Functional Block Copolymer and the Hydroxyl-Functional Acrylic Copolymer

This example differs from Example 11 in that another hybrid block copolymer structure was used, the diblock copolymer Polymer #3. This polymer has an EB rubber block of about 60,000 g/mol and a TBMA polymeric block of about 15,000 g/mol. This diblock copolymer was converted in an extruder to produce the glutaric anhydride block. This hybrid block copolymer does not contain an additional glassy polystyrene block. A modified acrylic adhesive was prepared as follows:

### Formulation A

100 phr of Polymer #3
120 phr of Regalrez 1085 resin
5 phr Drakeol 34
1 phr Irganox 1010
This formulation was prepared as a 20 wt % solution in 80/20 toluene/ethyl acetate
   Acrylic copolymer Solution

A 20 wt % solution of the NBA-co-2HEA copolymer (Example #10) was prepared in 10 grams of toluene and 2 grams of ethylacetate.

### Modified Acrylic Pressure Sensitive Adhesive

3.0 grams of Formulation A was mixed with 10 grams of the acrylic copolymer solution and heated to reflux for 4 hours. The reaction mixture was observed to increase in viscosity but did not gel. The resulting grafted product was used directly to coat substrates for adhesion testing.

### Adhesion Results:

180° Peel (pli) Stainless steel: 2.5 pli
180° Peel (pli) Polyethylene: 2.5 pli

Improved adhesion was observed versus the control from working Example 10a (unmodified acrylic copolymer) that has an average 180° Peel to polyethylene of 0.70 pli

### Prophetic Example 13

### Low Surface Energy (LSE) Performance of the Hybrid Pressure Sensitive Adhesives

In these examples, the 180° Peel to polyethylene film was measured using a standard ASTM test. The hybrid adhesives were prepared by making a 10 wt % solution of the hybrid copolymer and hydrogenated tackifying resin. The adhesive/resin solutions were prepared coating the adhesive on to a Mylar tape. The solvent was removed in a vacuum oven prior to testing.

### Prophetic Example 14

### Structural Acrylic Adhesive

The macromonomer of Example 6 was used to prepare and test structural acrylic adhesives by the methods described in U.S. Pat. No. 6,989,416. The catalyst component was an 18% benzoyl peroxide paste. A ratio of 10:1 (monomer component: catalyst component) was utilized.

To use the structural adhesive, the monomer component was combined with the catalyst component and applied to the work pieces which were then bonded together. The tensile strength, the elongation and the modulus of the resultant compositions were measured according to procedures set forth in ASTM D638-95, while the lap shear strength was measured according to ASTM D1002-94. The elastic recovery of a composition was calculated by creating strength versus stress curve based on the modulus of the composition. The linear portion of the curve corresponds to the elastic recovery of the composition.

A 35% solution of the macromonomer from Example 6 in methyl methacrylate was prepared and a 1% solution of naphthoquinone in methyl methacrylate was prepared. Additionally, a 10% solution of IGI 1977 (wax) in xylene was prepared. To the macromonomer solution was added the remaining methyl methacrylate. Next, in order, was added optionally the IGI 1977 (wax) solution, the naphthoquinone solution, the methacrylic acid, and the DMT (tertiary amine accelerator). These sub-components were mixed at about 800 rpm for 10 min. Next, the Zealloy 1422 (nitrile rubber) was optionally added while slowly increasing the mixing speed to about 900 rpm, where the speed is held for about 15 minutes. The mixture was allowed to sit for at least three hours, after which, the mixture was mixed at about 1200 rpm for 20 minutes to create a uniform consistency. Next the mixture was mixed at about 50 rpm while a vacuum is applied to remove any entrapped air from the mixture.

These formulations were tested and would be expected to exhibit an excellent balance of strength, elongation, stiffness, and elastic recovery. In addition, the formulations would be expected to show excellent properties even after long term aging at elevated temperatures such as would be found in an automobile either next to the engine or muffler or in a hot climate.

The composition for use as a structural adhesive, comprises an elastomeric component comprising, the hybrid block copolymer, optionally other elastomeric materials, also a methacrylate ester monomer, optionally an acid monomer, optionally a phosphate ester, optionally a cross-linked rubber, a tertiary amine initiator, an inhibitor, and a thixotropic agent; and a catalyst component. The hybrid polymer component is used at a level of 5-50% and most preferably at a level of 5-20%.

### Prophetic Example 15

### Radiation Cured Adhesive

The macromonomer of Example 6 was used to prepare and test radiation cured adhesives by the methods described in U.S. Pat. No. 4,556,464. 10-100 parts of the macromonomer of Example 6 were mixed with 0-100 parts of a styrenic block copolymer, 25-300 parts of a tackifying resin which was compatible with the hydrogenated butadiene block of the hybrid block copolymer, for example Regalrez 1126 (a hydrogenated pure monomer resin with 72° C. glass transition available from Eastman) and with optionally 0-300 parts of a plasticizer which was compatible with the hydrogenated butadiene block of the hybrid block copolymer, for example Drakeol 7 (mineral oil from Penreco), and optionally with an initiator which reacts with radiation to initiate the curing chemistry, for example a UV photoinitiator Irgacure 651 (Ciba Geigy) and optionally a crosslinking agent which can react in free radical based curing such as a difunctional or multifunctional acrylate like hexane diol diacrylate. The adhesives were prepared both by blending in a sigma blade mixer and by solution blending in toluene on a lab roller. They were cast onto Mylar, dried when cast from solution, cured with UV light and tested for adhesive properties. The adhesives are expected to show a good balance of tack and elevated temperature cohesive strength such as shear strength.

### Example 16

### Printing Plate (Prophetic Example)

The printing plate formulations were prepared at a total of 20% wt solids in toluene and mixed in bottles (wrapped in foil to prevent light exposure) on rollers. Solutions were poured into Mylar boats and dried in a hood for 25 days. During drying the films were covered to prevent light exposure. The 0.08 inch thick films were dried, and then irradiated in a UVP CL1000 chamber with 5 eight watt 365 nm UVA bulbs for twenty minutes on each side. A printing plate is made by solution casting from toluene a formulation of 89% of the macromonomer of Example 6, 10% hexane diol diacrylate, and 1% Irgacure 651. A second printing plate is made like the first except the macromonomer is replaced by a 1:1 mixture of the macromonomer of Example 8 and Kraton D1161P (a styrenic block copolymer with an isoprene midblock). A third printing plate is made like the first except the macromonomer is replaced by a 1:1 mixture of the macromonomer of Example 6 and Kraton D1102K (a styrenic block copolymer with a butadiene midblock). The printing plates comprising the hybrid block copolymer are expected to exhibit improved resistance to ozone compared to the printing plates of the prior art.

What is claimed is:

1. A contact adhesive composition comprising a hybrid block copolymer, a resin and a solvent, wherein said hybrid block copolymer comprises the reaction product of (a) a base block copolymer having at least one block of a polymerized conjugated diene or a polymerized alkenyl aromatic and at least one end block comprising six membered anhydride ring groups and acid groups, and (b) a reactive monomer or reactive resin or metal derivative that will react with the anhydride and/or acid groups of said end block.

2. The contact adhesive composition according to claim 1 wherein said base block copolymer prior to heating to form the anhydride rings and reaction with said reactive monomer or reactive resin or metal derivative comprises (a) a block of at least 80% by mole polymerized styrene, (b) a block of polymerized, hydrogenated butadiene having at least some 1,2-enchainments, or a block of polymerized, hydrogenated isoprene, or a block of polymerized, hydrogenated isoprene and butadiene and (c) a terminal block of polymerized t-butyl methacrylate polymerized through the ethylenic unsaturation thereof, wherein the block copolymer has the formula A-M, B-M, B-A-M, A-B-M or A-B-A′-M wherein A and A′ are blocks of the polymerized aromatic styrene, B is the block of the hydrogenated, polymerized butadiene, isoprene or mixtures of butadiene and isoprene, and M is the terminal block of the polymerized t-butyl methacrylate, and wherein each block of the polymerized styrene has a number average molecular weight from about 2,000 to about 50,000, the block of the hydrogenated, polymerized diene has a number average molecular weight from about 20,000 to about 500,000, and the terminal M block has a number average molecular weight of 500 to about 100,000.

3. The contact adhesive composition of claim 2 wherein said reactive monomer is selected from the group consisting of isocyanate monomers, monomers with a hydroxy group, monomers with a glycidyl group and mixtures thereof, and said reactive resin is selected from the group consisting of phenolic resins, amino resins, epoxy resins and polyurethanes.

4. The contact adhesive composition of claim 3 wherein said block M of said hybrid block copolymer prior to reaction with said reactive monomer or reactive resin or metal derivative contains 0 to 20 wt % ester groups, 0 to 100 wt % anhydride groups and 0 to 50 wt % acid groups, based on the weight of the M block, the total of said ester groups, anhydride groups and acid groups equaling 100 wt % of block M.

5. The contact adhesive composition of claim 4 comprising 100 parts by weight of said base block copolymer, 20 to 500 parts by weight of a heat reactive phenolic resin, 1 to 10 parts by weight of a metal oxide and a solvent.

6. An adhesive composition comprising 100 parts by weight of at least one hybrid block copolymer, 25 to 300 parts by weight of at least one tackifying resin, 0 to 200 parts by weight of an extender oil, wherein said hybrid block copolymer comprises the reaction product of (a) at least one base block copolymer of a polymerized conjugated diene or a polymerized alkenyl aromatic and at least one end block comprising six membered anhydride ring groups and acid groups, and (b) a reactive monomer or reactive resin that will react with the anhydride and/or acid groups of said end block.

7. The adhesive composition according to claim 6 wherein said base block copolymer prior to heating to form the anhydride rings and reaction with said reactive monomer or reactive resin comprises (a) a block of at least 80% by mole polymerized styrene, (b) a block of polymerized, hydrogenated butadiene having at least some 1,2-enchainments, or a block of polymerized, hydrogenated isoprene, or a block of polymerized, hydrogenated isoprene and butadiene and (c) a terminal block of polymerized t-butyl methacrylate polymerized through the ethylenic unsaturation thereof, wherein the block copolymer has the formula A-M, B-M, B-A-M, A-B-M or A-B-A′-M wherein A and A′ are blocks of the polymerized aromatic styrene, B is the block of the hydrogenated, polymerized butadiene, isoprene or mixtures of butadiene and isoprene, and M is the terminal block of the polymerized t-butyl methacrylate, and wherein each block of the polymerized styrene has a number average molecular weight from about 2,000 to about 50,000, the block of the hydrogenated, polymerized diene has a number average molecular weight from about 20,000 to about 500,000, and the terminal M block has a number average molecular weight of 500 to about 100,000.

8. The adhesive composition according to claim 7 wherein said block M of said hybrid block copolymer prior to reaction with said reactive monomer or reactive resin contains 0 to 20 wt % ester groups, 0 to 100 wt % anhydride groups and 0 to 50 wt % acid groups, based on the weight of the M block, the total of said ester groups, anhydride groups and acid groups equaling 100 wt % of block M.

9. The adhesive composition according to claim 8 wherein said reactive monomer is selected from the group consisting of isocyanate monomers, monomers with a hydroxy group, monomers with a glycidyl group and mixtures thereof, said reactive resin is selected from the group consisting of phenolic resins, amino resins, epoxy resins and polyurethanes; said tackifying resin is selected from the group consisting of hydrocarbon resins, rosin esters, rosin derivatives and mixtures thereof, said extender oil is selected from the group consisting of paraffinic and naphthenic oils and including a solvent selected from the group consisting of aromatic hydrocarbons, aliphatic hydrocarbons, polar oxygenated solvents, and mixtures thereof.

10. A toughened composition comprising a hybrid block copolymer, wherein said hybrid block copolymer comprises the reaction product of (a) a base block copolymer having at least one block of a polymerized conjugated diene or a polymerized alkenyl aromatic and at least one end block comprising six membered anhydride ring groups and acid groups, and (b) a reactive resin selected from the group consisting of epoxy resins, polyisocyanates and amino resins.

11. The toughened composition according to claim 10 wherein said base block copolymer prior to heating to form the anhydride rings and reaction with said reactive resin comprises (a) a block of at least 80% by mole polymerized styrene, (b) a block of polymerized, hydrogenated butadiene having at least some 1,2-enchainments, or a block of polymerized, hydrogenated isoprene, or a block of polymerized, hydrogenated isoprene and butadiene and (c) a terminal block of polymerized t-butyl methacrylate polymerized through the ethylenic unsaturation thereof, wherein the block copolymer has the formula A-M, B-M, B-A-M, A-B-M or A-B-A′-M wherein A and A′ are blocks of the polymerized aromatic styrene, B is the block of the hydrogenated, polymerized butadiene, isoprene or mixtures of butadiene and isoprene, and M is the terminal block of the polymerized t-butyl methacrylate, and wherein each block of the polymerized styrene has a number average molecular weight from about 2,000 to about 50,000, the block of the hydrogenated, polymerized diene has a number average molecular weight from about 20,000 to about 500,000, and the terminal M block has a number average molecular weight of 500 to about 100,000.

12. The toughened composition according to claim 11 wherein said reactive resin is an epoxy resin, said toughened composition comprising (a) from about 25 to 50 % w of said reactive epoxy resin, (b) from about 1 to 10% w of a block copolymer comprising a base block copolymer having at least one block of a polymerized conjugated diene or a polymerized alkenyl aromatic and at least one end block comprising six membered anhydride ring groups and acid groups and (c) from about 40 to about 70% w of a reactive curing agent for the epoxy resin.

13. The toughened composition according to claim 11 wherein said reactive resin is an aromatic polyisocyanate, an aliphatic polyisocyanate or mixtures thereof, said toughened composition comprising (a) from about 50 to 90% w of a block copolymer comprising a base block copolymer having at least one block of a polymerized conjugated diene or a polymerized alkenyl aromatic and at least one end block comprising six membered anhydride ring groups and acid groups, and (b) from about 10 to 50% w of said reactive resin.

14. The toughened composition according to claim 11 wherein said reactive resin is an amino resin selected from the group consisting of melamine-formaldehyde resins, glycoluril-formaldehyde resins and urea-formaldehyde resins, said toughened composition comprising (a) from about 60 to 90% w of a block copolymer comprising a base polymer having at least one block of a polymerized conjugated diene or a polymerized alkenyl aromatic and at least one end block comprising six membered anhydride ring groups and acid groups, (b) about 10 to 40% w of an amino resin, and (c) about 0.01 to 3% w acid catalyst.

15. An acrylic composition comprising an acrylic copolymer reacted with a block copolymer, wherein said acrylic copolymer has a glass transition temperature below 0° C. and contains at least one comonomer unit possessing a pendant reactive group capable of reacting with said block copolymer and wherein said block copolymer comprises at least one block of a polymerized conjugated diene and/or a polymerized alkenyl aromatic and at least one end block comprising a six membered anhydride ring and/or acid.

16. The acrylic composition of claim 15 wherein said acrylic composition is further reacted with an acrylic monomer selected from the group consisting of methyl acrylate, ethyl acrylate, isobutyl methacrylate, methyl methacrylate and mixtures thereof.

17. The acrylic composition of claim 16 wherein said acrylic copolymer is selected from the group consisting of (meth)acrylic ester/hydroxy(meth)alkyl ester copolymers, (meth)acrylic ester/glycidyl(meth)alkyl ester copolymers, (meth)acrylic ester/(meth)acrylic acid copolymers and (meth)acrylic ester/acrylamide copolymers

18. The acrylic composition according to claim 15 wherein said base block copolymer prior to heating to form the anhydride rings and reaction with said reactive monomer or reactive resin or metal derivative comprises (a) a block of at least 80% by mole polymerized styrene, (b) a block of polymerized, hydrogenated butadiene having at least some 1,2-enchainments, or a block of polymerized, hydrogenated isoprene, or a block of polymerized, hydrogenated isoprene and butadiene and (c) a terminal block of polymerized t-butyl methacrylate polymerized through the ethylenic unsaturation thereof, wherein the block copolymer has the formula A-M, B-M, B-A-M, A-B-M or A-B-A′-M wherein A and A′ are blocks of the polymerized aromatic styrene, B is the block of the hydrogenated, polymerized butadiene, isoprene or mixtures of butadiene and isoprene, and M is the terminal block of the polymerized t-butyl methacrylate, and wherein each block of the polymerized styrene has a number average molecular weight from about 2,000 to about 50,000, the block of the hydrogenated, polymerized diene has a number average molecular weight from about 20,000 to about 500,000, and the terminal M block has a number average molecular weight of 500 to about 100,000.

19. The acrylic composition of claim 15, wherein said acrylic copolymer comprises (a) at least one alkyl acrylate monomer containing from about 4 to about 18 carbon atoms in the alkyl group, and (b) at least one monomer selected from the group consisting of methyl acrylate, ethyl acrylate, isobutyl methacrylate, vinyl acetate, methyl methacrylate, acrylonitrile, styrene, and mixtures thereof, and wherein said functionalized block copolymer comprises the reaction product of (i) a block copolymer comprising at least one block of a polymerized conjugated diene or a polymerized alkenyl aromatic and at least one end block comprising a six membered anhydride ring and/or acid and (ii) at least one reactive monomer.

20. The acrylic composition of claim 19 wherein said reactive monomer is selected from the group consisting of hydroxy functional monomers, carboxy functional monomers, glycidyl functional monomers, acrylamide functional monomers, amine functional monomers, epoxy functional monomers, isocyanate functional monomers and mixtures thereof.

21. The acrylic composition of claim 20 wherein said acrylate monomer is selected from the group consisting of 2-ethyl hexyl acrylate, methyl acrylate, and hydroxy-ethyl acrylate.

22. The acrylic composition of claim 21 wherein said acrylic copolymer is crosslinked using a titanium crosslinking agent.

23. A functionalized block copolymer comprising the reaction product of (i) a block copolymer comprising at least one block of a polymerized conjugated diene or a polymerized alkenyl aromatic and at least one end block comprising a six membered anhydride ring and/or the acid formed from the reaction of this ring and water and (ii) at least one reactive component selected from the group consisting of functional monomers, acrylic copolymers containing a pendant reactive group, and reactive resins.

24. The functionalized block copolymer of claim 23 wherein (i) said functional monomer is selected from the group consisting of hydroxy functional monomers, carboxy functional monomers, glycidyl functional monomers, acrylamide functional monomers, amine functional monomers, epoxy functional monomers, isocyanate functional monomers and mixtures thereof; (ii) said acrylic copolymer containing a pendant reactive group has a glass transition temperature below 10° C.; and (iii) said reactive resin is selected from the group consisting of phenolic resins, amino resins and epoxy resins.

25. The functionalized block copolymer of claim 23 wherein said base block copolymer prior to heating to form the anhydride rings and reaction with said reactive component comprises (a) a block of at least 80% by mole polymerized styrene, (b) a block of polymerized, hydrogenated butadiene having at least some 1,2-enchainments, or a block of polymerized, hydrogenated isoprene, or a block of polymerized, hydrogenated isoprene and butadiene and (c) a terminal block of polymerized t-butyl methacrylate polymerized through the ethylenic unsaturation thereof, wherein the block copolymer has the formula A-M, B-M, B-A-M, A-B-M or A-B-A′-M wherein A and A′ are blocks of the polymerized aromatic styrene, B is the block of the hydrogenated, polymerized butadiene, isoprene or mixtures of butadiene and isoprene, and M is the terminal block of the polymerized t-butyl methacrylate, and wherein each block of the polymerized styrene has a number average molecular weight from about 2,000 to about 50,000, the block of the hydrogenated, polymerized diene has a number average molecular weight from about 20,000 to about 500,000, and the terminal M block has a number average molecular weight of 500 to about 100,000, and wherein said block M of said block copolymer prior to reaction with said functional monomer or acrylic copolymer or reactive resin contains 0 to 20 wt % ester groups, 0 to 100 wt % anhydride groups and 0 to 50 wt % acid groups, based on the weight of the M block.
